(19) United States
(12) Patent Application Publication
(10) Pub. No.: US 2026/0149288 A1
(43) Pub. Date: May 28, 2026

(54) ANALYSIS OF MICROGRID PERFORMANCE, RELIABILITY, AND RESILIENCE (AMPERRE) COMPUTATIONAL MODEL

(71) Applicant: United States of America as Represented by The Secretary of The Army, Alexandria, VA (US)

(72) Inventors: Jessica J. Nicholson, Champaign, IL (US); Matthew Gross, Champaign, IL (US); Thomas Bozada, Champaign, IL (US); Daniel C. Herring, Newton, MA (US)

(21) Appl. No.: 19/397,218

(22) Filed: Nov. 21, 2025

Related U.S. Application Data
(60) Provisional application No. 63/724,071, filed on Nov. 22, 2024.

(51) Int. Cl. H02J 3/46; H02J 3/00; H02J 3/28; H02J 3/38

(52) U.S. Cl. CPC H02J 3/46; H02J 3/004; H02J 3/28; H02J 3/388; H02J 2103/30

(57) ABSTRACT

An example discrete, time-domain computational method finds optimal power resources in a microgrid for reliability and resilience. The method involves receiving, by an input module, inputs including microgrid parameters, control conditions, natural resource datasets, and a load profile for the microgrid. The method forecasts, by a forecasting module based on the inputs, forecasted values for a plurality of power grid outcomes related to reliability and resilience, to inform power resource investment decisions. The method generates, by a forecasted results generator, a results report including the forecasted values. The results report is readable by several stakeholders, including Military installations, remote communities, campuses, and institutions.

### FIELD OF THE TECHNOLOGY

The present disclosure relates generally to analyzing and forecasting microgrid performance, reliability, and resilience.

### BACKGROUND

Federal facilities, industrial areas, academic campuses, and communities are working to incorporate greater renewable energy sources and energy storage in their power infrastructure. While renewable sources of energy can—and do—support several facilities, uncertainty still exists about how reliably these sources of energy can support small and/or critical power systems with higher reliability standards such as Army installations, tactical microgrids, remote community grids, and emergency response power systems. Maintaining reliability is already a significant challenge for power grids, and those that have a high proportion of renewable energy face particular challenges due to their intermittent power production.

It is important to understand how power resources are most commonly used. Current power systems typically contain one of the following resource configurations: fuel-based dispatchable sources such as generators to supplement utility power; fuel-based dispatchable sources that serve as a primary source; fuel-based dispatchable sources with supporting renewables; fuel-based dispatchable sources with supporting energy storage; or fuel-based dispatchable sources with supporting renewables and energy storage.

Conventional power systems commonly prioritize dispatchable, fuel-based resources to provide power to the load. Renewables are treated as supporting sources due to their intermittence. These systems rarely make optimal use of the energy produced by the renewable sources and consume more fuel as a result. Existing power grids may experience barriers to the prioritization of renewable energy sources, so many have not taken this step. Energy storage is often treated as reserve power in the event of adverse conditions rather than as a tool to capture surplus energy from renewable sources. Surplus energy is often wasted, but if it is captured, it minimizes the need to use fuel-based sources. When conventional power projects do choose to implement a control system that prioritizes renewables, these projects face challenges in determining the quantity of renewable resources and energy storage needed to achieve reliability and resilience objectives. The projects often “overbuild,” or compensate for this uncertainty by incorporating an excess quantity of certain renewable resources and energy storage for periods of low power generation. This can prove to be costly and resource intensive, leading many projects to stick to the prioritization of fuel-based sources. It is possible to minimize the need for “overbuilding” through analysis to forecast how well a power grid would reach reliability and resilience objectives for different quantities of renewable sources, energy storage, and supporting dispatchable energy. Current methods to perform such an analysis are underdeveloped.

### SUMMARY

In an embodiment, a discrete, time-domain computational method finds optimal power resources in a microgrid for reliability and resilience. The method involves receiving, by an input module, inputs including microgrid parameters, control conditions, natural resource datasets, and a load profile for the microgrid. The method forecasts, by a forecasting module based on the inputs, forecasted values for a plurality of power grid outcomes related to reliability and resilience, to inform power resource investment decisions. The method generates, by a forecasted results generator, a results report including the forecasted values. The results report is readable by several stakeholders, including Military installations, remote communities, campuses, and institutions.

In another embodiment, a non-transitory computer readable medium has instructions stored thereon executable by a processor to perform a discrete, time-domain computation that finds optimal power resources in a microgrid for reliability and resilience. The instructions, when executed, cause the processor to receive, by an input module, inputs including microgrid parameters, control conditions, natural resource datasets, and a load profile for the microgrid. The processor forecasts, by a forecasting module based on the inputs, forecasted values for a plurality of power grid outcomes related to reliability and resilience to inform power resource investment decisions. The processor generates, by a forecasted results generator, a results report including the forecasted values. The results report is readable by several stakeholders, including Military installations, remote communities, campuses, and institutions.

### BRIEF DESCRIPTION OF THE DRAWINGS/FIGURES

FIG. 1 is a diagram of how AMPeRRe models power flow according to an example.

FIG. 2 is a diagram illustrating the impact of added power resources on power grid outcomes according to an example.

FIG. 3 is a diagram of power grid outcome tradeoffs according to an example.

FIG. 4 is a block diagram of a detailed calculation process for AMPeRRe according to an example.

FIG. 5 is a chart of power curve model examples, according to an example.

FIG. 6 is a chart of error magnitude of power curve model for each wind speed, according to an example.

FIG. 7 is a chart of percent error of power curve model for each wind speed, according to an example.

FIG. 8 is a chart of stored energy vs time with one tier of reserve energy maintained by generators, according to an example.

FIG. 9 is a chart of stored energy vs time with tiered reserve maintained by generators, according to an example.

FIG. 10 is a chart illustrating how dispatched power D[t] impacts the number of generators operating |Gₒ[t]|, according to an example.

FIG. 11 is a histogram chart illustrating number of generators operating, according to an example.

FIG. 12 is a chart illustrating a total fuel consumption curve dependent on the set of generators operating, according to an example.

FIG. 13 is a chart illustrating a rate of fuel consumption histogram, according to an example.

FIG. 14 is a block diagram with disturbance signals to model power resource losses, according to an example.

FIG. 15 is a chart of visualized depletion of stored energy for a loss of six of 10 generators and eight of 10 MW solar, calculated survival time, according to an example.

FIG. 16 is a diagram of ideal vs non-ideal load-sharing between generators, according to an example.

FIG. 17 is a chart of user-input load profile and plotted time-domain AMPeRRe results, according to an example.

FIG. 18 is a chart of calculated duty cycle for each dispatchable source (in this example, diesel generators) in a power system, according to an example.

FIG. 19 is a chart of frequency of stored energy state-of-charge levels, according to an example.

FIG. 20 is a chart of frequency of fuel-based sources operating with different rates of fuel consumption, according to an example.

FIG. 21 is a table of a set of comparative AMPeRRe results for different input configurations, according to an example.

FIG. 22 is a chart of generator duty cycle (%)—primary utility involvement, no utility outage, according to an example.

FIG. 23 is a chart of number of times that a generator must activate over the course of a year, according to an example.

FIG. 24 is a chart comparing the yearly fuel consumption of different resource mix scenarios, according to an example.

FIG. 25 is a chart showing the fuel savings caused by the inclusion of renewables and energy storage, according to an example

FIG. 26 is a chart showing the number of days between fuel resupply, according to an example.

FIG. 27 is a chart showing the comparative excess energy produced in each power mix scenario.

FIG. 28 is a chart showing microgrid survival time given different quantities of generator power loss, according to an example.

FIG. 29A and FIG. 29B are charts showing generator duty cycle, according to an example.

FIG. 30 is a chart showing yearly fuel consumption, according to an example.

FIG. 31 is a chart showing days between fuel resupply, according to an example.

FIG. 32 is a chart showing energy provided by utility, according to an example.

FIG. 33 is a chart showing energy demand fulfilled by renewables, according to an example.

FIG. 34 is a chart showing generator duty cycle, according to an example.

FIG. 35 is a chart showing yearly fuel consumption, according to an example.

FIG. 36 is a flowchart to generate a results report according to an example.

FIG. 37 is a block diagram of a computing system including an input module, a forecasting module, and a forecasted results generator according to an example.

FIG. 38 is a block diagram of a computing system including an input module, a forecasting module, and a forecasted results generator according to an example.

### DETAILED DESCRIPTION

Embodiments described herein present a new computational model called Analysis of Microgrid Performance, Reliability, and Resilience (AMPeRRe). The model forecasts the power availability, fuel consumption, specific resilience factors, and excess energy production of proposed microgrids that include renewable energy sources and energy storage. If proposed grids are forecasted to lose power availability, users can apply this model to find which resources are needed to achieve 100% power availability and optimize resource quantities for ideal performance outcomes. AMPeRRe significantly reduces uncertainty around renewable energy and energy storage in power grids and informs the critical resource investment decisions needed to yield improved long-term outcomes.

Energy demand continues to grow on a global scale. Due to this, implementing sustainable energy solutions is becoming increasingly critical while transitioning our energy infrastructure away from costly fuel-based sources. The long-term reliability and resilience of islanded power grids in global communities and industry depends on the ability to make strategic investments that optimize cost and resources. While many entities aim to incorporate greater renewable energy sources in their islanded power infrastructure, renewable energy sources and energy storage systems create additional challenges within the system that must be managed. Sources such as photovoltaic solar and wind power create system variability due to the intermittent natural resources necessary to generate power. Challenges such as these must be addressed to make more effective use of power grid assets, manage variability, ensure continuous power service, achieve operational objectives, and accommodate the loss of utility power. Fuel-based sources and energy storage, for example, have dispatchable generation that can act as secondary power sources and maintain power availability during renewable power shortage while the microgrid is islanded.

On the other hand, incorporating a greater proportion of renewable energy and energy storage in power grids can make them more self-sufficient, cost-effective, and environmentally friendly. A greater understanding of the outcomes of renewable energy integration can lead to informed investment decisions that allow power grids to reach performance objectives despite the associated challenges.

Analysis of Microgrid Performance, Reliability, and Resilience (AMPeRRe) forecasts several quantitative reliability and resilience-related power grid outcomes to determine the optimal ratio of power resources for case-by-case power systems. These outcomes inform power grid decision-makers of the objectives they can achieve given resource limitations and constraints. The outcomes include power availability, survival time, fuel consumption, generator duty cycle, and excess energy production. By forecasting each of these outcomes, AMPeRRe can determine the resources needed in renewable-inclusive power grids to achieve optimal survival time, component use, and fuel consumption. Results provided by this model can lead to reliable renewable energy implementation, optimize the set of resources within a power grid, and ultimately improve reliability and resilience outcomes. Given this adaptability, AMPeRRe can positively impact many federal, public, industrial, and residential power systems.

Embodiments of AMPeRRe include different variations of the calculation process to account for different microgrid resources and prioritizations. One variation can evaluate islanded power grids, while two others can evaluate utility-connected microgrids. The “islanded” microgrid power supply priority involves renewables, energy storage, and dispatchable sources that rely on liquid fuel. The renewables supply directly to the load, and surplus renewable power charges the battery. The energy storage charges during renewable surplus, and discharges to the load during shortage. The liquid fuel supplies to the load during shortage to maintain a reserve battery charge.

The “primary” utility-connected variation counts the utility as a primary power source. This variation assumes that the on-site renewables, energy storage, and liquid fuel-based microgrid resources will only provide power support in the event of utility outage or if intentional limits are placed on utility power. In contrast, the “integrated” utility variation treats the utility as a source that is integrated with the microgrid. On-site renewable energy and energy storage sources take priority in supplying power to the load. The utility is counted as a tertiary support that only contributes during renewable and energy storage shortages, and it is prioritized over on-site fuel-based dispatchable resources.

Conventional power grid resources, configurations, and control methods can be modeled in AMPeRRe as baseline scenarios, or existing infrastructure, in the beginning stages of an analysis. AMPeRRe has the ability to quantify the value of proposed advancements to these grids, or the addition of new energy resources, by comparing the baseline performance of such conventional grids to the performance outcomes that the model forecasts given the implemented advancements.

Factors that contribute to rapidly growing electrical demand are the growing implementation of electric vehicles, fabrication of hydrogen fuel and other clean fuel, and the increasing reliance on electrical systems in daily lives. This increase in energy demand requires that power grids be modernized to handle several changing conditions and evolving consumer needs. The incorporation of alternative energy sources and storage in these grids can contribute to this modernization objective. It is important for power grids to make optimal use of their assets, which can achieve: maximized reliability and resilience; greater mission readiness; improved power grid self-sufficiency; improved environmental sustainability; and prolonged life of power grid components.

Maximizing the use of intermittent renewable energy resources can improve power grid self-sufficiency and sustainability. Rather than prioritizing fuel-based dispatchable sources as conventional systems do, some modernized grids incorporate alternate control methods that maximize the power drawn from renewable energy sources. This may involve the strategic use of energy storage to increase the capture of surplus renewable energy. Some modernized power systems only use dispatchable energy sources if the renewable power and stored energy become insufficient to provide for current demand. Examples of resource configurations in modernized islanded power grids include: renewable energy sources with energy storage that captures power during periods of surplus and supplies power during shortage; and renewable energy sources with energy storage and supporting fuel-based dispatchable power sources that operate when stored energy becomes critically low.

Despite the benefits, prioritizing intermittent renewable energy creates a greater level of uncertainty about whether planned quantities of renewable energy sources will provide adequate power to fulfill demand. The power output of solar and wind energy resources depends on the availability of their associated natural resources-direct normal solar irradiance and wind speed. These patterns of availability are difficult to predict long-term and are not often well-matched to power demand. These uncertainties present the need for detailed analyses to determine whether systems with renewable sources can supply adequate power to specific demand profiles. Many power grid decision-makers lack the capability to perform these analyses in a simple and cost-effective way. Conventional power systems may instead “overbuild,” as described in the previous section. To prevent this, modernized power grid projects can use tools or perform calculations to predict the optimal quantified mix of resources needed to reach their operational goals. While this adds complexity to the planning process, a proper analysis can lead to long-term savings and better outcomes compared to conventional grids. AMPeRRe provides these analysis capabilities.

As power grids modernize through the incorporation of renewables and energy storage, unique challenges must be overcome to ensure maintained reliability and resilience. Three questions have prompted research and driven the development of AMPeRRe: What are the measurable outcomes and objectives associated with success in self-sufficient power grids? Outcomes are measures of a power grid's performance. Objectives are the defined, desired states that a power grid's outcomes must reach to determine its level of success. Objectives are set on a case-by-case basis, often dependent on requirements and applications specific to the proposed grid. Can a mathematical model accurately predict power grid outcomes to determine how well the grid would achieve defined objectives? On a case-by-case basis, can such a model predict whether the incorporation of resources such as renewables and energy storage would improve power grid outcomes (and fulfill defined objectives)?

AMPeRRe aims to reduce complexity around the planning of power grids with a high proportion of renewable energy and energy storage. Rather than spend time and resources performing evaluations to develop reliability and resilience-related predictions, power grid planners can use the AMPeRRe model. This model enables users to choose the grid configuration, or resource mix, that achieves reliability and resilience goals by optimizing one or more of the following measurable outcomes: maximize power availability—the grid's ability to maintain power service given full functionality during business-as-usual conditions. Maximize survival time—the grid's ability to maintain service during component failure, measured as the time from component failure to loss of service. Minimize overall fuel consumption-minimized fuel consumption reduces costs, transport, and aids self-sufficiency and resilience. Minimize the duty cycle of fuel-based dispatchable sources. Minimize magnitude and duration of power shortages. Minimize wasted energy.

AMPeRRe quantifies the value of adding different energy sources and supporting energy storage in power grids to account for evolving needs and increasing energy demand. Given the new level of understanding provided by this model, the proposed inclusion of renewable energy within islanded power grids can show reduced fuel consumption without compromised function or performance. Users can apply this model in specific facilities, installations, and remote communities that aim to decarbonize, minimize fuel consumption, and minimize costs. AMPeRRe results consistently demonstrate renewable-inclusive power grids' capability to be fully available, clean, cost-effective, and resilient during power source failure. It provides users the information needed to determine the ratio of renewable and non-renewable resources that optimizes these outcomes. This informs asset selection to progress the implementation of new resources in several types of grids and microgrids.

AMPeRRe is an accurate, repeatable calculation model that can inform investment decisions for a variety of power applications, and can be based on: identifying critical and measurable power grid outcomes related to performance, reliability, and resilience; developing a repeatable calculation model to forecast how well proposed power grids would achieve these outcomes; and incorporating this model into proposed power grid planning processes to provide the results needed to make informed decisions.

The scope of the AMPeRRe model covers islanded and utility-connected power grids with solar arrays, wind turbines, energy storage systems, and/or fuel-based dispatchable power generation. It can evaluate power grids of any scale. The model is a discrete, time-stepped analysis, so fidelity of the results is affected by the chosen timestep length. The shorter the timesteps between data points in input and intermediate datasets, the more accurate the user can expect the results to be. The specific metrics used in AMPeRRe to perform this analysis are described further below. AMPeRRe is particularly applicable to federal, public, industrial, and residential power grids that have significant challenges maintaining power availability and resilience. These include grids that: are isolated, islanded, or remote/without utility connection or robust fuel transport routes; contain critical loads and strict reliability requirements; incorporate a high proportion of renewables and energy storage; and experience high variability in location-based conditions-load; ambient temperature; direct normal solar irradiance and generated solar power; and wind speed and generated wind power.

Results described herein may include various components and features. Some of the components and features may be removed and/or modified without departing from a scope of the method, system, and non-transitory computer readable medium for providing analysis of microgrid performance, reliability, and resilience. Numerous specific details are set forth to provide a thorough understanding of the examples. However, the examples may be analyzed without limitation to these specific details and the AMPeRRe model may be practiced without limitation to these specific examples. In other instances, previously defined methods and structures used to produce these example results may not be described in detail to avoid unnecessarily obscuring the description of the examples. Also, the examples may be used in combination with each other. As used herein, a component is a combination of hardware and software executing on that hardware to provide a given functionality.

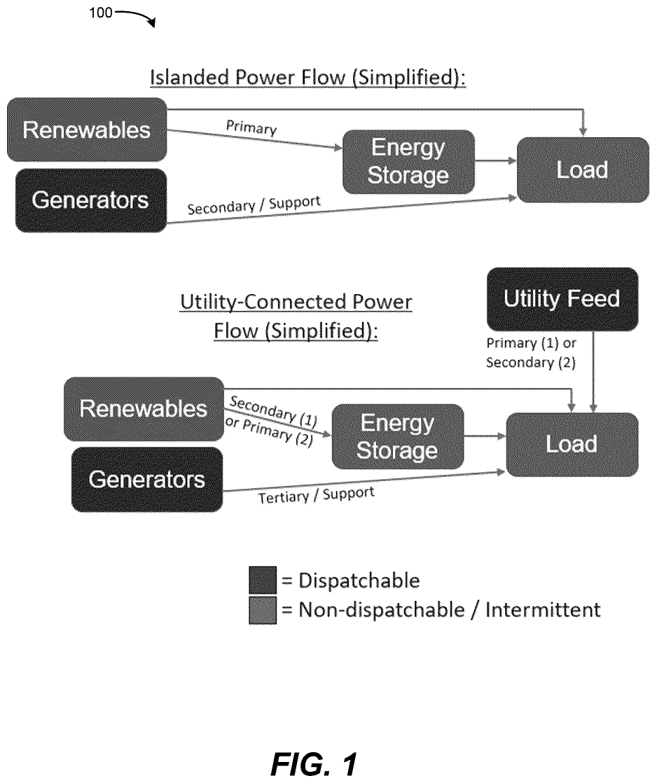

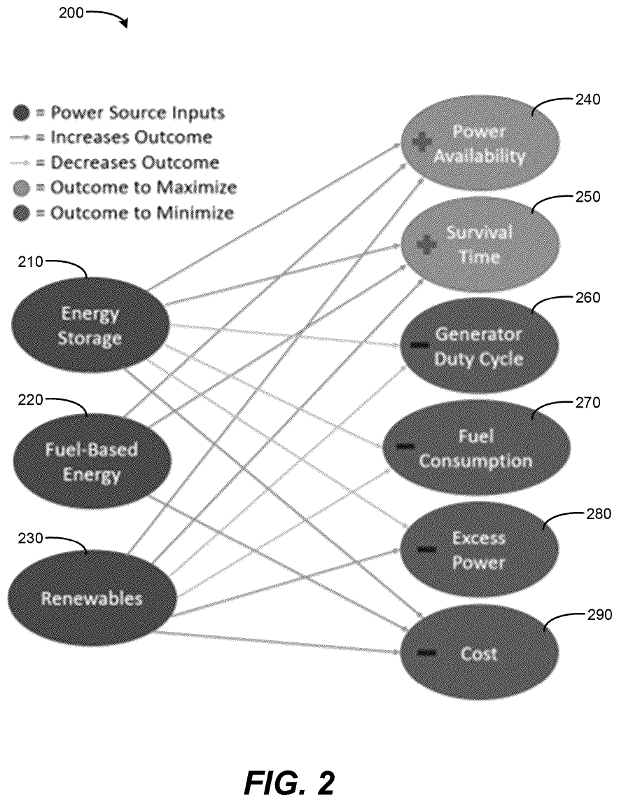

FIG. 1 is a diagram 100 of how AMPeRRe models power flow according to an example. A simplified power flow from each source to load is illustrated. Embodiments of the islanded variation can use the following power resource supply priority: 1) renewable energy-solar and wind (renewables); 2) energy storage-battery (energy storage); 3) liquid fuel combustion-generators (dispatchable energy). Embodiments of the utility-connected variations can use the following power resource supply priority: 1) Utility feed or renewable energy, depending on which variation is used; 2) Renewable energy or energy storage, depending on which variation is used; 3) Energy storage or utility feed, depending on which variation is used; 4) Liquid fuel combustion. FIG. 1 refers to this priority using terminology of primary, secondary, and tertiary/support. This modeled power resource priority and power flow control system define how changes in the quantity of each power resource impact forecasted grid outcomes. These trends are shown in FIG. 2.

FIG. 2 is a diagram 200 illustrating the impact of added power resources on power grid outcomes. The power source inputs are on the left side. On the right side, ovals marked with a plus sign are outcomes with the objective to maximize, and ovals marked with a minus sign are outcomes with the objective to minimize. Lines terminating at power availability 240, survival time 250 and cost 290, and also the line from renewables 230 to excess power 280, represent forecasted outcomes that would increase due to added power resources. Lines terminating at generator duty cycle 260 and fuel consumption 270, and also the line from energy storage 210 to excess power 280, represent forecasted outcomes that decrease due to added resources. Magnitudes of each outcome change are dependent on the specific power grid scenario inputs.

A high proportion of renewable energy in a grid can promote significant decarbonization and contribute to meeting climate goals. Renewable energy integration in a power grid is classified as “very high” if the renewable energy within the grid provides a minimum of 50% annual energy demand with the capability of providing up to 100% of the demanded instantaneous power. Renewable energy causes greater intermittence in generated power, however, which leads to less predictable power generation, instability, and decreased reliability if not supported by energy storage and/or dispatchable energy. It is important to incorporate a balance of renewables that contributes to optimal power grid performance objectives without losing power availability.

Increased renewable energy incorporation allows a grid to supply a greater proportion of the load with renewables, decreasing the need for liquid fuels. The less fuel the site needs, the less frequently it requires fuel transport. Lower fuel transport creates a more self-sufficient power grid and makes the grid more resilient to extreme conditions outside of the area. If renewables are an additional power source to a conventional fuel-based grid, the grid may have a greater survival time in the event of component failures. A greater variety of power sources decreases the chance that extreme natural conditions cause significant damage to the full power grid.

The greater the energy storage capacity incorporated into the microgrid, the more surplus renewable energy can be captured. This prevents excess energy and allows renewables to contribute more energy to the grid despite their intermittence. High-capacity energy storage systems are also more equipped to sustain power throughout long-lasting renewable shortages. To maintain power availability, users choose a reserve energy threshold. If the modeled battery charge falls below this threshold, dispatchable fuel sources compensate for any renewable energy shortage to prevent the battery charge from depleting further. The more frequent and severe renewable power shortages are expected to be, the greater the quantity of reserve energy is needed to maintain power availability.

AMPeRRe can find the energy storage capacity that maximizes the capture of generated renewable energy and therefore minimizes fuel consumption. Energy storage is costly, so the incorporation of additional energy storage to achieve this would likely increase the expected system cost. Users must choose, based on case-by-case objectives, whether to prioritize the minimization of resource costs or fuel consumption in the sizing of an energy storage system. A power system is more likely to have a high survival time if it has high energy storage capacity, as it will likely have more stored energy at any moments of failure. The allowable charge and discharge rate of energy storage must be high enough to capture excess power and supply power during all magnitudes of shortage. If a power shortage exceeds the discharge rate that the energy storage system is capable of, AMPeRRe accounts for this discrepancy and other dispatchable sources must provide supplemental power during the time period.

Realistically, many power grids still rely on dispatchable fuels to offset shortages of renewable energy and maintain power availability. AMPeRRe can model fuel-based dispatchable power sources as supports. Several methods of dispatch exist to maintain power availability during shortages, and AMPeRRe models a control system that minimizes fuel consumption. The model adheres to a function that matches generator output to the shortage of renewable power when the battery charge drops below a reserve threshold.

Fuel is costly, produces emissions, and requires transportation for resupply. Reliance on liquid fuel hinders a power grid's ability to be self-sufficient. While many power grids use fuels as a dispatchable power source, it is possible to significantly reduce the fuel consumption of a power grid. By prioritizing non-fuel-based sources, AMPeRRe generates a scenario of minimal fuel consumption given the selected energy resources. The more renewable energy sources included in the modeled power grid, the more renewable energy can contribute to the load. The higher the energy storage capacity in the system, the more produced renewable energy is captured during periods of surplus. Both choices decrease the fuel consumption required for the power grid to maintain power availability.

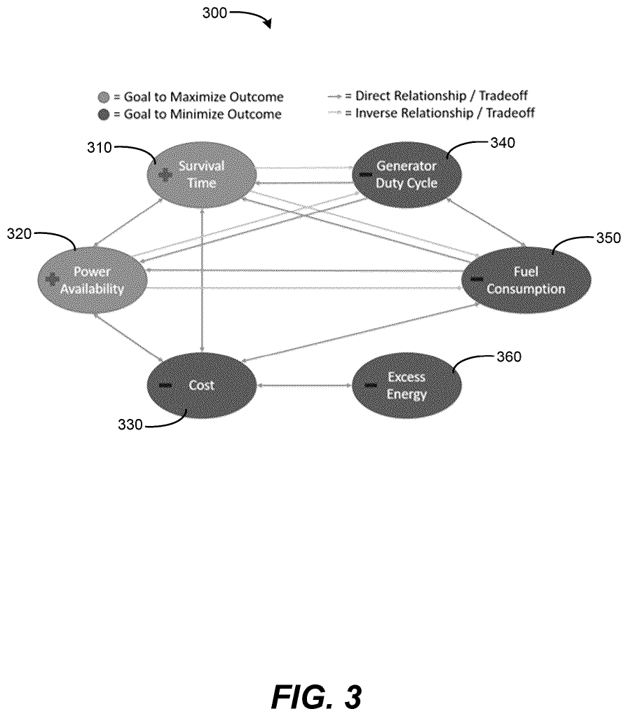

FIG. 3 is a diagram 300 of power grid outcome tradeoffs according to an example. AMPeRRe enables quantitative forecasted power grid outcomes and objectives, and provides the forecasted results needed to understand whether power grids would achieve defined reliability and resilience-related objectives. Proposed power grids with a high proportion of renewable energy can minimize fuel consumption, for example, but they must also meet reliability and resilience objectives to reduce the uncertain power availability surrounding their intermittence. As the power system parameters are changed in AMPeRRe, tradeoffs often occur between forecasted outcomes. Changes to the power grid that benefit survival time may raise costs, while those that minimize fuel consumption may risk losing power availability. FIG. 3 expresses the tradeoffs that AMPeRRe exhibits among commonly desired power grid outcomes. Green connections represent direct tradeoffs, where an increased quantity of one outcome has an impact on another outcome that would cause it to increase. Yellow connections represent inverse tradeoffs, where an increased quantity of one outcome would result in the decrease of another.

AMPeRRe can maximize power availability (reliability). Power availability is the percentage of time that a power grid meets demand during its period of operation. A system that provides continuous power supply to the load has a power availability of 100%. The primary objective of a power grid is to provide continuous service, so a proposed power grid's availability must be validated as 100%. If high load or low power generation are forecasted to cause loss of power supply, AMPeRRe will return a power availability result below 100%. The power availability required from a microgrid depends on the loads it supports. The more critical the system, the higher the power availability standard it must adhere to. Many power availability standards fall within the range of 99.99% to 99.9999%.

AMPeRRe can minimize utility energy contribution. Utility power can be costly and incorporate fossil fuel production, so minimizing the contribution of utility energy to an installation load can reduce overall costs. Minimizing utility contribution can also lower carbon footprint if this utility contribution is offset by clean energy generation.

AMPeRRe can maximize renewable energy contribution. Maximizing renewable energy contribution can reduce costs and improve resilience, as renewable energy does not require fuel. Despite its intermittence, it is possible to supply a significant amount of load using renewable energy—given support from energy storage—and reach the maximum possible renewable energy contribution while retaining power availability.

AMPeRRe can minimize fuel-based dispatchable source energy contribution. Fuel-based dispatchable sources such as generators are costly to operate due to their fuel consumption, so minimizing their involvement while maintaining power availability is both cost-effective and sustainable.

AMPeRRe can maximize survival time (resilience). In the event of a power grid failure, survival time is the measured duration of time from the start of the failure to the loss of power service. AMPeRRe's survival time output shows a user how long their power grid would continue to provide service once failure occurs. Users can model any combination of failures among the power sources within the power grid, as well as the start and end time of each failure. The longer the survival time forecasted by AMPeRRe, the more resilient the power grid is to the modeled failure.

AMPeRRe can minimize excess energy (cost). If a power grid is producing more energy than it can capture, this excess energy must be managed. This is a necessity when the battery charge is nearing capacity and cannot capture additional energy surplus. If the power surplus is greater than the battery charge rate, the grid must also manage excess power. Excess energy may be curtailed, sold to a connected utility, or filtered out of the grid. Curtailment occurs when a microgrid controller intentionally halts power generation from specific power sources to prevent the system from being overloaded. Energy filtered out would be lost to the surroundings, but if the grid is connected to a utility, energy could instead be redirected back to the utility. If power grids can minimize excess energy production, this energy can instead be used productively toward serving the load. Doing so can make the grid more cost-effective and minimize the need for fuel-based support.

AMPeRRe can minimize magnitude and duration of power shortages (reliability and resilience). The greater the intermittence of power generation or variability of the load, the more likely load will exceed generated power. If load exceeds generated power for a significant amount of time, there is a greater chance that stored energy reserves will fully deplete and cause a loss of service. Traditionally, power grids have incorporated over-sized renewable power sources or energy storage compared to the load to compensate for this intermittence. The greater the variability in the system, the larger the power grid must be relative to the load to maintain power availability. This is a cost-intensive solution, however. The preferable alternative is to design a grid with renewable power generation patterns that align as well as possible with common load profile patterns. The better the grid's collective power generation pattern matches needs, the less frequently shortages will occur and the smaller these shortages will be. The less severe the power shortages, the more likely a system is to have continuous power availability and high survival times.

AMPeRRe can minimize liquid fuel consumption (self-sufficiency and decarbonization). The rate of fuel consumption from a fuel-based dispatchable energy source is dependent on its power output at any given time. In a generator-inclusive power grid, for example, this means that the rate of fuel consumption from each generator will vary depending on the power demanded from the generator. When a power grid has one or multiple fuel-based power sources, AMPeRRe calculates the system's total fuel consumption over a period of time. The higher the quantity of renewable energy sources within a grid, the less power is required of the fuel-based sources on average and the less fuel they will consume. The less fuel consumed, the more effectively the power grid can reach self-sufficiency and decarbonization objectives.

AMPeRRe can minimize dispatchable power source duty cycles (cost-effectiveness and robustness), defined as the percentage of time that a power source is in operation. AMPeRRe monitors the timesteps that dispatchable sources must operate and forecasts the duty cycle of these sources within the system. Similar to fuel consumption, the duty cycle of fuel-based sources within a system will decrease if greater quantities of renewable energy sources are included in the grid. The more renewable energy sources included in the grid, the less frequently fuel-based sources must operate to support the grid and the lower the forecasted duty cycles. The lower the duty cycles of these sources, the longer their lifespan is expected to be and the lower the costs associated with maintenance and replacement.

The following high-level procedural overview presents an example calculation process and explains how AMPeRRe performs power grid evaluation. A process is described that quantifiably forecasts the outcomes described above.

Renewable energy incorporation can be a first piece of AMPeRRe's process, to calculate the generated power from each intermittent renewable power source at each timestep and model the contribution of these sources to the load. AMPeRRe's calculation process can be performed by a forecasting module, to maximize renewable power contribution to the load by prioritizing these sources as the first to fulfill demand. Any surplus power is collected in an energy storage system, and renewable-produced energy is only treated as excess when energy storage is at capacity. The following stages describe the input collection (e.g., as performed by an input module) and a calculation process within, e.g., a forecasting module of AMPeRRe:
1. Gather known power grid parameters and natural resource data
   a. Determine the solar, wind, battery, inverter, and generator components included in the conceptual power grid
   b. Gather load data from the facilities of interest
   c. Use the National Solar Radiation Database (NREL 2023) or a similar source to gather the annual natural resource data sets needed for the calculation process (Select the location, year, and time step length equivalent to that of the load data)
      i. Direct normal solar irradiance
      ii. Ambient temperature
      iii. Wind speed
2. Calculate generated wind power at every time step
   a. Mathematically model the manufacturer power curve of each wind turbine model to create a set of generated power values that correspond to the wind speed data
3. Calculate generated solar power at every time step using direct normal solar irradiance data
4. Create a power surplus data set by calculating the difference between total renewable power produced and corresponding load data
   a. Positive values represent power surplus while negative values represent power shortage
5. Using the surplus data set, calculate the proportion of load supplied by renewable energy corresponding to each time step
6. Calculate the power availability of the renewable-only grid; the proportion of positive surplus values
   a. Power availability calculations below 100% indicate the need for supporting energy storage and/or dispatchable power generation in the planned power grid

Energy Storage Inclusion and Dispatchable Power Support is next. If the renewable sources yield a low power service availability, the user can find the energy storage capacity and dispatchable power generation needed to support periods of shortage and reach a theoretical service availability of 100%. AMPeRRe can also evaluate existing storage and controlled generation within a proposed grid to determine whether these sources enable sufficient power availability. If any power surplus or shortage data points exceed the energy storage system's maximum charge and discharge rates, the energy storage system will limit how much energy is collected during these excess surplus periods and how much energy is discharged during excess shortage. These determinations can be performed by the input module and the forecasting module. This portion of the analysis assumes a business-as-usual scenario, while the survival time analysis (see below) can model power resource failures or disconnections:
1. Create a running total of the chronological renewable power surplus data set and apply bounds to remain between zero and the input storage capacity
2. Calculate the power availability of the renewable and storage-inclusive power grid; the proportion of time steps for which the stored energy is greater than zero
3. Apply a control algorithm that contributes dispatchable power to the stored energy running total when two conditions are simultaneously met:
   a. Stored energy drops below a defined reserve charge
   b. The power from renewable energy is in shortage
4. Choose the proportion of shortage that the dispatchable power will offset during operation
   a. A proportion >100% of the shortage would charge the energy storage system until it returns to a value above the reserve charge
   b. A proportion=100% of the shortage would maintain the current stored energy until the renewable power returns to a state of surplus
   c. A proportion <100% of the shortage would allow the energy storage to undergo slow depletion until the renewable power returns to a state of surplus
5. Calculate the power availability of the renewable, storage, and dispatchable-inclusive power grid; the proportion of time steps for which the stored energy is greater than zero
   a. If the power availability is <100%, it can be increased by increasing the energy storage system's reserve charge
6. Populate the “generators running” dataset by choosing the load factor; the proportion of rated power for which additional generators (or other dispatchable sources) are activated
7. Calculate the rate of fuel consumption at each timestep using the known fuel consumption curves, dataset of generators running, and dispatchable source power output dataset
8. Find the total yearly fuel consumption and average rate of fuel consumption using an AMPeRRe-generated rate of fuel consumption dataset
9. Calculate the average number of days between fuel resupply for comparison to an existing, or baseline, scenario
10. Calculate the excess energy at every timestep due to lack of available energy storage capacity
11. Calculate the excess energy at every timestep due to insufficient allowable charge rate

AMPeRRe can be used for determining resilience/survival time. Power grids will not always operate as expected or remain in business-as-usual scenarios. Extreme natural conditions, deterioration from prolonged use, power surges, and intentional attacks—among other things—have the potential to cause power resource outage(s) for a known or unknown time period. It is important to design power grids that are resilient to these possible adverse conditions, and the design of a resilient power grid is most effective if decision-makers understand how the proposed grid will respond to different power resource losses. AMPeRRe is capable of modeling power resource losses to plan for the possibility of these failures. A user can introduce disturbance signals that exclude solar, wind, generator, or battery resources from contributing to the load during a specified time period. This feature is capable of modeling any simultaneous combination of resource failures. AMPeRRe then determines whether the power grid maintains service throughout the failure(s). If the power grid does not maintain service, AMPeRRe provides an estimated survival time. The following steps briefly describe this portion of the AMPeRRe calculation process, which can be performed by the forecasting module:
1. Confirm that AMPeRRe calculates 100% power availability for the business-as-usual power grid
2. Choose any quantity of the incorporated solar to model its failure or loss for a specific start and end time
3. Choose any of the incorporated wind turbines to model their failure or loss for a specific start and end time
4. Choose any quantity of the incorporated energy storage capacity to model its failure or loss for a specific start and end time
5. Choose any combination of the incorporated dispatchable energy sources to model their failure or loss for a specific start and end time
6. Determine whether the system maintains power service despite failure throughout the chosen time period
7. If AMPeRRe shows a loss of power service, determine the survival time associated with the modeled failures
   a. Survival time is measured as the elapsed time from the start of a failure to the loss of power service
8. Observe resulting changes in AMPeRRe's calculated outcomes: power availability, duty cycle of dispatchable sources, excess energy, and fuel consumption

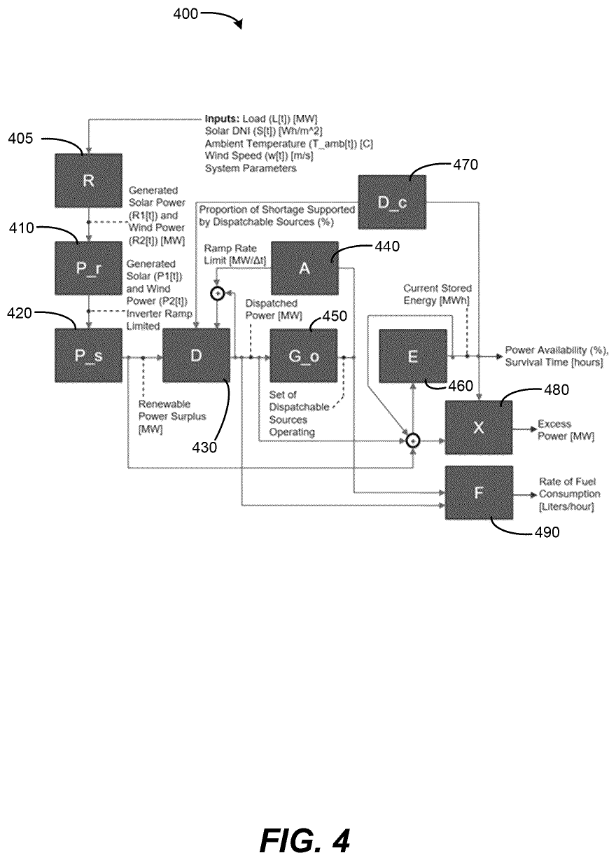

FIG. 4 is a block diagram 400 of a detailed calculation process for AMPeRRe according to an example. This section expands the above procedure and describes the full calculation process behind AMPeRRe's capabilities. It is a thorough explanation of the variables, formulas, control factors, feedback loops, disturbance signals and other algorithms incorporated in AMPeRRe to achieve numerical forecasted outcome results for proposed power grids. All variables used in these formulas are listed below.

AMPeRRe intelligently prompts for, and collects, inputs (e.g., from a user) to evaluate a proposed power grid. AMPeRRe can use an input module, which comprises one or more of the control blocks illustrated in FIG. 4, to obtain the inputs that are relevant to a given scenario. In an embodiment, the input module can determine which types of power resource prioritizations are relevant to a given scenario, and then prompt for further inputs relevant to that prioritization. In an example, inputs for which the input module prompts can be defined and characterized as:
1. Solar Array Parameters:
   a. Rated power
   b. Temperature coefficient
   c. Nominal operating cell temperature
2. Wind Turbine Parameters:
   a. Manufacturer
   b. Power curve (power output vs wind speed)
   c. Blade radius
   d. Altitude/height
   e. Air density associated with altitude
3. Inverter Parameters:
   a. Size/rated power
   b. Efficiency
   c. Ramp-up rate limit
   d. Ramp-down rate limit
4. Energy Storage System Parameters:
   a. Manufacturer
   b. Energy storage capacity
   c. Maximum charge and discharge rate
   d. Round-trip or charge/discharge efficiency
   e. Average parasitic load (If not included in full load profile)
5. Fuel-Based Dispatchable Source Parameters:
   a. Number of systems
   b. Rated power of each system
   c. Power acceptance rates
   d. Fuel consumption curves
6. Chronological Load Data:
   a. Time step length
   b. Collective power load data from the location of interest
7. Location-Based, Chronological Natural Resource Data:
   a. Direct normal solar irradiance
   b. Wind speed
   c. Ambient temperature

AMPeRRe applies the following assumptions and control system variables by default, and can use the input module to prompt for and accept user input to change the assumptions and control variables as desired to model alternate conditions:
1. The maximum charge and discharge rate (in kW) of an energy storage system are ½ of its capacity (kWh)
2. Initial stored energy is set to the first tier of the user-determined reserve energy storage values (E_{reserve,1})
3. Fuel-based dispatchable sources will only supply power to the load if renewable power is in shortage
4. Current state of stored energy determines the proportion of renewable power shortage that dispatchable sources will offset

AMPeRRe also has input variables that users can alter to represent different feedback and control system scenarios. These are not defined system parameters, but they change how the dispatchable sources and energy storage units respond to current states:
1. Tiered reserve energy storage levels—A set of energy thresholds for which dispatchable sources support different proportions of renewable power shortage
2. Tiered proportions of dispatchable source support—The set of proportions of renewable power shortage that dispatchable sources support at different energy storage levels
3. Load factor—If the dispatchable sources are generators, the load factor is the threshold proportion of rated generator power that increases the number of generators operating when it is surpassed
4. Peak-shaving power limit—An upper limit applied to dispatchable power sources and the utility to model peak-shaving

AMPeRRe can perform renewable power calculations. AMPeRRe uses a forecasting module, with can comprise one or more control blocks illustrated in FIG. 4, to generate forecasted values or other outcomes (e.g., power availability or survival time from block 460, excess power from block 480, rate of fuel consumption of block 490, etc.). The following describes the renewable power component of the AMPeRRe mathematical process needed to evaluate each proposed renewable-inclusive power system for power availability, survival time, and fuel consumption. Equations 1, 2 and 3 calculate the power produced from a set of solar arrays c₁[t] at any given moment. Direct normal solar irradiance S[t] is a resource that varies with time at the location of interest, and users can find this data from NREL's National Solar Radiation Database (NSRDB) (NREL 2023). NSRDB can also provide the ambient temperature T_{amb}[t] data needed in this calculation process.

$$Equation 1 : PV Solar Generated Power$$

$${R}_{1} [ t ] = {\sum }_{i ∈ {c}_{1} [ t ]} {C}_{1 , i} * S [ t ] * {n}_{loss , i} [ t ] * {e}_{inverter , i} \qquad ( 1 )$$

$$Equation 2 : Efficiency Representing Loss due to Temperature Increase$$

$${n}_{loss} [ t ] = 1 - λ ( {T}_{cell} [ t ] - 25 ) \leq 1 else {n}_{loss} [ t ] = 1 \qquad ( 2 )$$

$$Equation 3 : Temperature of the PV Cells$$

$${T}_{cell} [ t ] = {T}_{amb} [ t ] + ( \frac{S [ t ]}{800} * ( {T}_{NOCT} - 20 ) ) \qquad ( 3 )$$

Wind turbine models have differing power coefficients and power curves. Equation 4 is a mathematical model designed to closely fit a wind turbine power curve. For systems with multiple wind turbines, generated wind power vs time must be calculated for each individual wind turbine “i” within the set of operating turbines c₂ [t]. All the generated wind power datasets are summed together to represent the total contribution of wind power to the load at every timestep.

$$Equation 4 : Wind Turbine Power Curve Mathematical Model$$

$${R}_{2} [ t ] = {\sum }_{i ∈ {c}_{2} [ t ]} \frac{{C}_{2 , i}}{( 1 + {a}_{i} {e}^{- {k}_{i} w [ t ]} )} \qquad ( 4 )$$

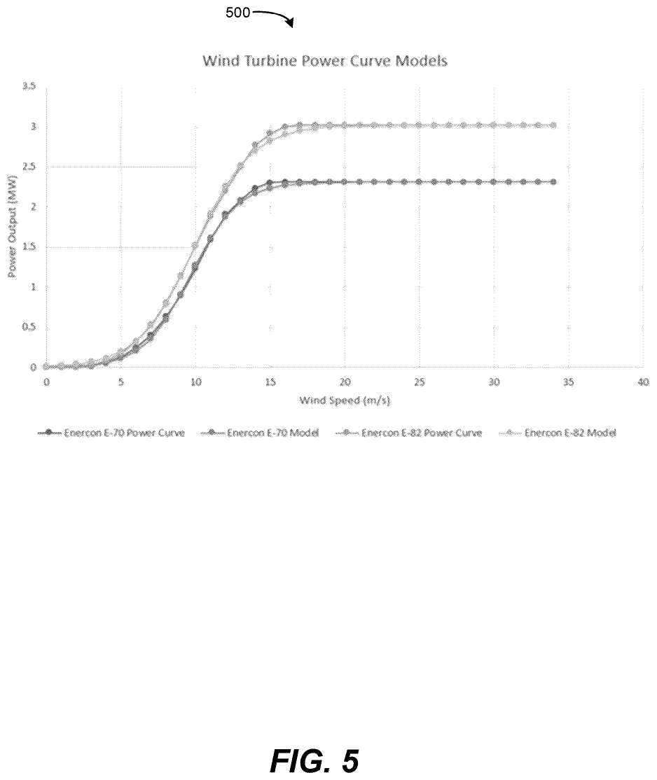

For each wind turbine, the coefficient “aᵢ” and growth rate “kᵢ” must be set to values for which the resulting formula yields the maximum correlation coefficient to the power curve it models. AMPeRRe applies an optimization algorithm to select the “a” and “k” coefficients that maximize the correlation coefficient. FIG. 5 and Table 1 demonstrate how Equation 4, with AMPeRRe-selected coefficients, closely fits two example wind turbine power curves-Enercon E-70 and E-82.

AMPeRRe uses a forecasted results generator to generate a results report, which includes various forecasted values, such as the output of various blocks illustrated in FIG. 4. The results report can include various charts, as illustrated and described below.

FIG. 5 is a chart 500 of power curve model examples, according to an example. FIG. 5 illustrates wind turbine power curve models.

TABLE 1
correlation associated with examples of power curve models

| Formula Coefficients E-70 | | Formula Accuracy E-70 | |
|---|---|---|---|
| Rated Power [c] | 2.31 | Correl. Coefficient | 0.9997109 |
| a | 454.6984819 | r\hat{ }2 | 0.9994218 |
| k | 0.631623504 | | |
| Formula Coefficients E-82 | | Formula Accuracy E-82 | |
| Rated Power [c] | 3.02 | Correl. Coefficient | 0.9997004 |
| a | 203.8902398 | r\hat{ }2 | 0.9994009 |
| k | 0.533682682 | | |

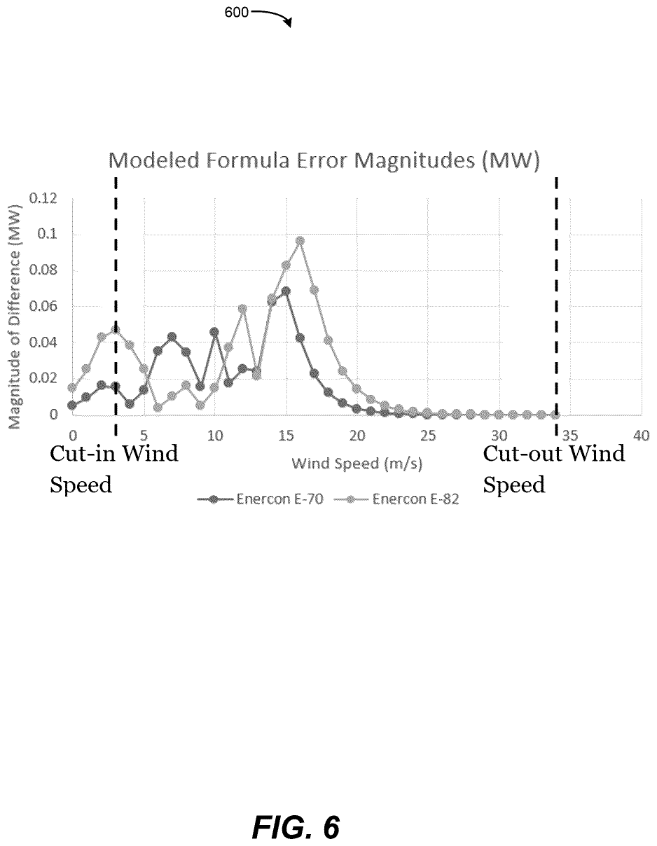

FIG. 6 is a chart 600 of error magnitude of the power curve model for each wind speed, according to the above example.

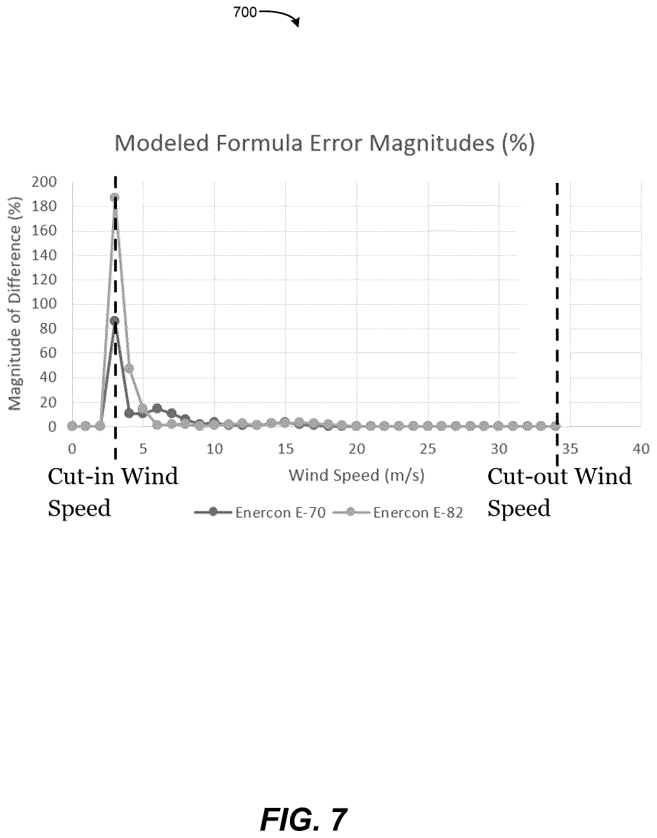

FIG. 7 is a chart 700 of percent error of the power curve model for each wind speed, according to the above example.

The correlation coefficient of these two close-fit curves and the error magnitude shown in FIGS. 6 and 7 demonstrate that with proper “aᵢ” and “kᵢ” coefficients, the model in Equation 6 is a good match for standard wind turbine power curves. Percent error is high at the lowest wind speed values after the cut-in speed, but this can be attributed to low power curve values relative to the magnitude of difference between the power curve value and the mathematical model value. This model will yield power output vs time results when used to calculate generated wind power from wind speed data.

$$Equation 5 : Generated Solar or Wind Power with Inverter Ramp Limits$$

$${P}_{j} [ t ] = {R}_{j} [ t ] for {P}_{j} [ t - 1 ] - {\sum }_{i ∈ {c}_{j}} {R}_{rampdown , i} < Δ {R}_{j} [ t ] < {P}_{j} [ t - 1 ] + {\sum }_{i ∈ {c}_{j} [ t ]} {R}_{rampup , i} \qquad ( 5 )$$

$$Equation 6 : Inverter Ramp Rate Limit on Generated Solar or Wind Power$$

$$\begin{matrix}{P}_{j} [ t ] = {P}_{j} [ t - 1 ] + {\sum }_{i ∈ {c}_{j}} {R}_{rampup , i} for \\ {R}_{j} [ t ] - {P}_{j} [ t - 1 ] > {P}_{j} [ t - 1 ] + {\sum }_{i ∈ {c}_{j}} {R}_{rampup , i} \\ {P}_{j} [ t ] = {P}_{j} [ t - 1 ] - {\sum }_{i ∈ {c}_{j}} {R}_{rampdown , i} for \\ {R}_{j} [ t ] - {P}_{j} [ t - 1 ] < {P}_{j} [ t - 1 ] - {\sum }_{i ∈ {c}_{j}} {R}_{rampdown , i}\end{matrix} \qquad ( 6 )$$

While the R₁[t] and R₂[t] functions calculate generated solar and wind power respectively, inverter ramp rates must be considered as they place a limit on the rate of increase or decrease in generated power. Equation 5 applies this limit by maximizing any change in generated power to the ramp rate from one timestep to the next. If a change between timesteps is calculated to be of greater magnitude than the ramp rate, Equation 6 applies conditions to keep the change equivalent to the ramp rate.

$$Equation 7 : Total Renewable Power ( W )$$

$${P}_{r} [ t ] = {P}_{1} [ t ] + {P}_{2} [ t ] \qquad ( 7 )$$

$$Equation 8 : Surplus of Renewable Power ( W )$$

$${P}_{s} [ t ] = {P}_{r} [ t ] - L [ t ] \qquad ( 8 )$$

Equation 7 sums the power produced by both solar and wind to calculate the total renewable power produced at each timestep. Equation 8 calculates the quantity of renewable power exceeding the load at every timestep. Positive values indicate a surplus of renewable power in the system, while negative values indicate a shortage.

The following relates to dispatchable power source support and energy storage. Dispatchable sources such as generators can supply power to the system to account for periods of power shortage and prevent loss of power service to the load.

$$Equation 9 : Support Dispatchable Power Provided to System ( W )$$

$$D [ t ] = {D}_{c} [ t ] * \vert {P}_{s} [ t ] \vert for D [ t - 1 ] - A [ t ] < D [ t ] - D [ t - 1 ] < D [ t - 1 ] + A [ t ] and D [ t ] \leq {\sum }_{i ∈ {G}_{a} [ t ]} {P}_{gen , i} \qquad ( 9 )$$

$$Equation 10 : Input Tiers of Dispatchable Power Support$$

$$\begin{matrix}d = [ {d}_{1} … {d}_{p} ] \\ {E}_{reserve} = [ {E}_{reserve , 0} … {E}_{reserve , p} ]\end{matrix} \qquad ( 10 )$$

$$Equation 11 : Conditions of Dispacthable Source Support$$

$$\begin{matrix}{D}_{c} [ t ] = {d}_{i} for {P}_{s} [ t ] < 0 and {E}_{reserve , i - 1} \leq E [ t ] < {E}_{reserve , i} \\ else {D}_{c} [ t ] = 0 \\ 1 \leq i \leq p , 0 \leq {d}_{i} \leq 1 , {E}_{reserve , 0} = 0\end{matrix} \qquad ( 11 )$$

Users can input a set of proportions and energy reserve thresholds in Equation 10 to control how involved the dispatchable power sources will be at different states of stored energy. In other words, these user-input variables define the proportion of renewable energy shortage the dispatchable sources will offset depending on current stored energy. The time-based variable D_{c}[t] in Equation 11 is a numerical multiplier applied to Equation 9 that reflects dispatchable power output. D_{c}[t] is greater than zero when two simultaneous conditions are met:
1. The collective power output from renewable sources is in shortage
2. The battery charge is below the top tier reserve charge E_{reserve,p}

By default, AMPeRRe applies two tiers of dispatchable power source support. Dispatchable sources provide power to offset the full proportion of power shortage (D_{c}[t]=d₁=1) when stored energy falls within the range of an input reserve value and zero charge (E_{reserve,0}<E[t]<E_{reserve,1}). Dispatchable sources do not provide any power (D_{c}[t]=d₂=0) when stored energy is above the reserve value and below available capacity (E_{reserve,1}<E[t]<E_{cap}[t]).

$$Equation 12 : Default Tiers of Dispatchable Source Support$$

$$\begin{matrix}d = [ {d}_{1} , {d}_{2} ] = [ 1 , 0 ] \\ {E}_{reserve} = [ {E}_{reserve , 0} , {E}_{reserve , 1} ] = [ 0 , {E}_{reserve , 1} ]\end{matrix} \qquad ( 12 )$$

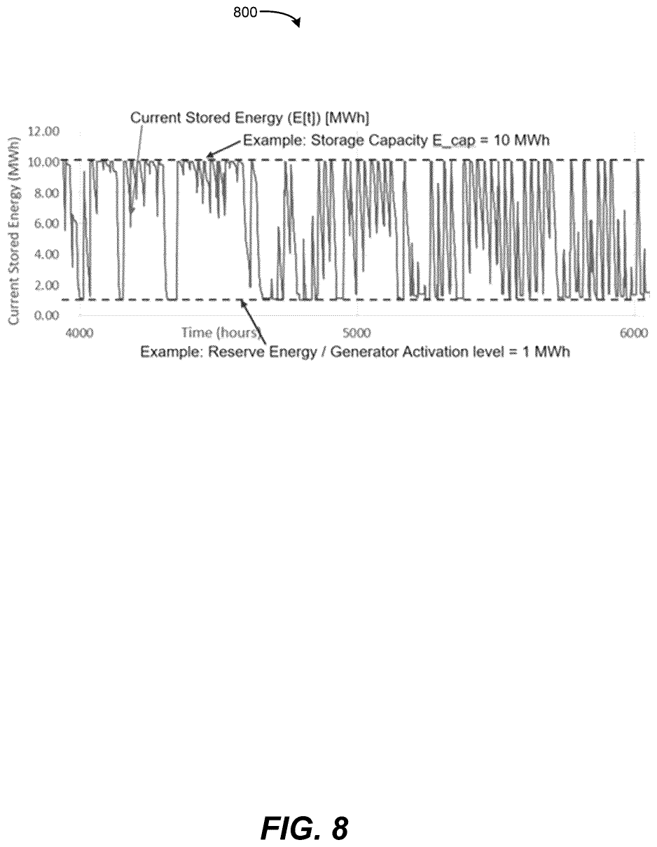

FIG. 8 is a chart 800 of stored energy vs time with one tier of reserve energy maintained by generators, according to an example. FIG. 8 shows an example of the default scenario, where dispatchable power sources offset the full magnitude of shortage to ensure no energy depletion when stored energy reaches a user-defined reserve threshold. Periods of stored energy that reach the reserve threshold (1 MWh) will remain at this state of charge rather than dropping below due to activated dispatchable power support. When stored energy is above this threshold, the energy storage source depletes to offset renewable power shortage rather than the dispatchable sources. This prioritization of stored energy minimizes fuel-based dispatchable power involvement and minimizes fuel consumption.

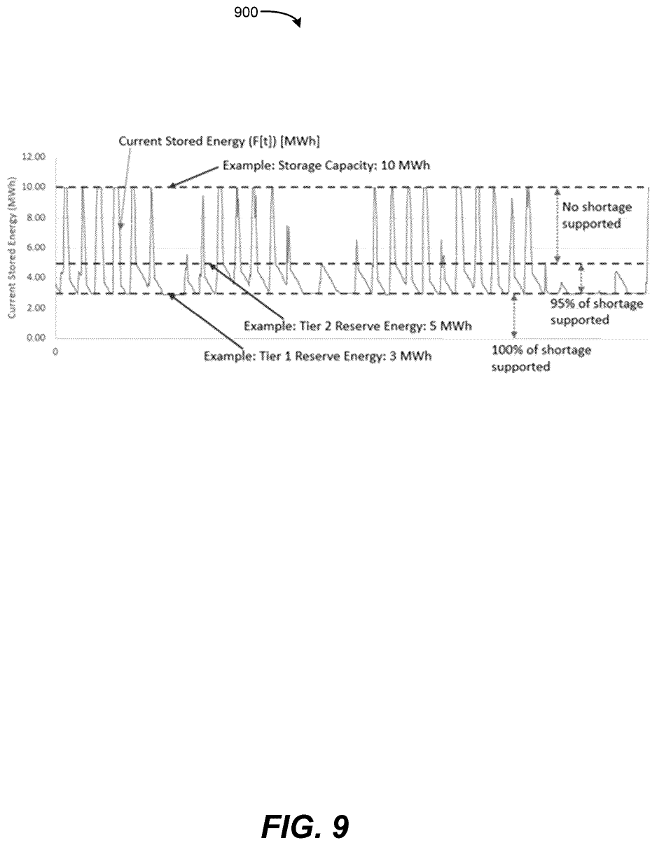

AMPeRRe allows users to deviate from the default scenario as needed. Users can change the energy reserve threshold and the proportion of power shortage that generators offset during periods of support. The process also allows for additional tiers of shortage-proportional generator support depending on current stored energy. FIG. 8 and Equation 12 represent the default scenario, while Equation 13 and FIG. 9 show an example of a scenario that deviates from default conditions with an additional tier. This additional tier provides generator support for 95% of renewable power shortage when the stored energy nears the first reserve threshold. In this example, energy discharge is slower when the stored energy is between 3 and 5 MWh because generators offset 95% of any power shortages. This allows for a slower ramp-up of dispatchable power support as stored energy drops compared to the default scenario in FIG. 8.

$$Equation 13 : Example of 3 - Tier Dispacthable Source Support$$

$$\begin{matrix}d = [ {d}_{1} , {d}_{2} , {d}_{3} ] = [ 1 , 0.95 , 0 ] \\ {E}_{reserve} = [ {E}_{reserve , 0} , {E}_{reserve , 1} , {E}_{reserve , 2} ] = [ 0 , 3 , 5 ]\end{matrix} \qquad ( 13 )$$

FIG. 9 is a chart 900 of stored energy vs time with tiered reserve maintained by generators, according to an example.

Similar to renewable power, the rate of change of generator power output D[t] is limited by a generator power acceptance rate. Inertia is associated with the operation of both inverters and generators, so these components are limited in how quickly they can adjust their power output. To model this limit of change in power output, Equation 14 limits the magnitude of change in D[t] to the acceptance rate A[t].

$$Equation 14 : Generator Acceptance Rate Limit on Dispacthable Power$$

$$\begin{matrix}D [ t ] = D [ t - 1 ] + A [ t ] for Δ D [ t ] > D [ t - 1 ] + A [ t ] \\ D [ t ] = D [ t - 1 ] - A [ t ] for Δ D [ t ] < D [ t - 1 ] - A [ t ]\end{matrix} \qquad ( 14 )$$

The acceptance rate is a variable rather than a constant because the set of generators operating varies over time, impacting the acceptance rate of the full generator set. Equation 15 shows this relation between the set of generators operating Gₒ[t] and the acceptance rate A[t]. The variable R_{gen,i} represents the acceptance rate limit of one generator.

$$\begin{matrix}Equation 15 : Collective Generator Acceptance Rate & \\ A [ t ] = {\sum }_{i ∈ {G}_{o} [ t ]} {R}_{gen , i} & ( 15 )\end{matrix}$$

The set of generators operating Gₒ[t] in Equation 16 depends on the power output required of the generators D[t] and the set of available generators. The load factor “LF” represents the proportion of the total rated generator power that, when the demanded power output D[t] reaches this value, additional generator(s) are activated to share the load. This allows the power demand to be shared between a greater number of generators. The demand on each individual generator will drop to prevent overload. If the number of generators operating |Gₒ[t]| must be larger than the number of generators in the system |Gₐ[t]| to meet the D[t] condition, the set of generators operating is limited to the set of generators available.

$$\begin{matrix}Equation 16 : Set of Generators Operating & \\ {G}_{o} [ t ] = [ ∅ ] for D [ t ] = 0 else {G}_{o} [ t ] = [ 1 ... k [ t ] ] ∈ {G}_{a} [ t ] & ( 16 )\end{matrix}$$

$$k [ t ] = min ( i ∈ {G}_{a} [ t ] ) for which {\sum }_{i ∈ {G}_{o} [ t ]} {P}_{gen , i} \geq \frac{D [ t ]}{LF}$$

$$while \vert {G}_{o} [ t ] \vert \leq \vert {G}_{a} [ t ] \vert$$

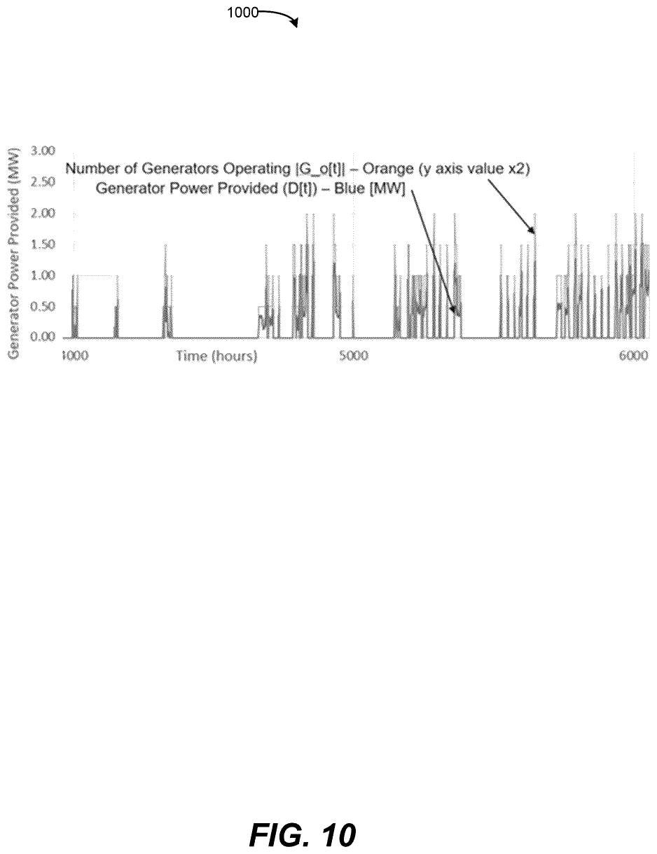

FIG. 10 is a chart 1000 illustrating how dispatched power D[t] impacts the number of generators operating |Gₒ[t]|, according to an example. FIG. 10 shows an example of the dispatchable power D[t] changing in the time domain as well as the number of generators operating (number of items in set Gₒ[t]) to fulfill this demand.

If the power grid contains energy storage, the renewable power surplus Pₛ[t] and generator power output D[t] contribute to the stored energy. The stored energy E[t], or state of charge, at each timestep is determined by summing these power contributions and adding them to the previous stored energy timestep as shown in Equation 17 to create a running total of energy in watt-hours. FIG. 8 is an example of this stored energy plotted to visualize how it changes with time.

$$\begin{matrix}Equation 17 : Current Stored Energy / State of Charge ( kWh ) & \\ E [ 0 ] = {E}_{reserve , 1} & ( 17 )\end{matrix}$$

$$E [ t ] = {P}_{s} [ t ] + D [ t ] + E [ t - 1 ] for 0 \leq E [ t ] \leq {E}_{cap}$$

$$E [ t ] = 0 for E [ t ] < 0 and E [ t ] = {E}_{cap} [ t ] for E [ t ] > {E}_{cap} [ t ]$$

$$\begin{matrix}Equation 18 : Charge Rate Limit on State of Charge & \\ E [ t ] = E [ t - 1 ] + {R}_{charge} for {P}_{s} [ t ] + D [ t ] > {R}_{charge} & ( 18 )\end{matrix}$$

$$else E [ t ] = Min ( {E}_{cap} , {P}_{s} [ t ] + D [ t ] + E [ t - 1 ] )$$

$$\begin{matrix}Equation 19 : Discharge Rate Limit on State of Charge & \\ E [ t ] = E [ t - 1 ] - {R}_{discharge} for {P}_{s} [ t ] + D [ t ] < {R}_{discharge} & ( 19 )\end{matrix}$$

$$else E [ t ] = Max ( 0 , {P}_{s} [ t ] + D [ t ] + E [ t - 1 ] )$$

The following relates to results: power availability, excess power, and fuel consumption. If stored energy fully depletes while the collective renewable and dispatchable sources are in shortage to the load, the power grid will lose service to the load. Equation 20 shows that timesteps with a battery charge greater than 0 (E[tᵢ]>0) or have collective renewable and dispatchable power greater than or equal to the load (Pₛ[tᵢ]+D[tᵢ]≥0) contribute to the power availability summation. Power availability is calculated at 100% if the battery charge never reaches 0, and power availability drops below this 100% for each timestep that both above conditions are simultaneously unmet.

$$\begin{matrix}Equation 20 : Power Availability of the Power Grid ( \% ) & \\ S = \frac{100}{{t}_{total}} * {\sum }_{i = 1}^{i = {t}_{total}} \begin{matrix}( 1 for ( E [ {t}_{i} ] > 0 or \\ {P}_{s} [ {t}_{i} ] + D [ {t}_{i} ] \geq 0 ) else 0 )\end{matrix} & ( 20 )\end{matrix}$$

If the power availability is <100% in a system that includes dispatchable power sources, two factors may contribute to this. The number of dispatchable sources and their collective rating may be insufficient to supply to the load during the highest quantities of renewable power shortage. To address this, a user can add higher levels of alternative energy sources to reduce the magnitude of the shortages that the dispatchable sources must account for. If this does not significantly reduce shortage magnitudes, the user can add more dispatchable sources to raise their collective rated power.

Equation 21 shows how AMPeRRe calculates the proportion of load supplied by renewable energy at any given timestep and the average proportion during the measured period.

$$\begin{matrix}\begin{matrix}Equation 21 : Proportion of Load \\ Supplied by Renewable Energy\end{matrix} & \\ {P}_{VRE} [ t ] = 1 - \frac{\vert {P}_{s} [ t ] \vert}{L [ t ]} for {P}_{s} [ t ] < 0 else {P}_{VRE} [ t ] = 1 & ( 21 )\end{matrix}$$

$${P}_{VRE , avg} = \frac{{\sum }_{i = 1}^{i = {t}_{total}} {P}_{VRE} [ {t}_{i} ]}{{t}_{total}}$$

During timesteps with stored energy at capacity or power surplus that exceeds the allowable charge rate, some of this surplus power cannot be captured and must be treated as excess power. This excess power may be curtailed, filtered out of the system, or provided to a utility if the grid is utility-connected. Equations 22 and 23 calculate excess power at each timestep, which are then summed to determine the total excess energy during the evaluated time period.

$$\begin{matrix}\begin{matrix}Equation 22 : Excess Power due to \\ Lack of Available Battery Capacity\end{matrix} & \\ {X}_{1} [ t ] = ( {P}_{s} [ t ] + D [ t ] + E [ t - 1 ] ) - {E}_{cap} for & ( 22 )\end{matrix}$$

$$E [ t ] = {E}_{cap} else {X}_{1} [ t ] = 0$$

$$\begin{matrix}\begin{matrix}Equation 23 : Excess Power due to \\ Insufficient Allowable Charge Rate\end{matrix} & \\ {X}_{2} [ t ] = ( {P}_{s} [ t ] + D [ t ] ) - {R}_{charge} for & ( 23 )\end{matrix}$$

$${P}_{s} [ t ] + D [ t ] > {R}_{charge} else {X}_{2} [ t ] = 0$$

$$\begin{matrix}Equation 24 : Total Excess Power & \\ X [ t ] = {X}_{1} [ t ] + {X}_{2} [ t ] & ( 24 )\end{matrix}$$

Using the Gₒ[t] dataset in multi-generator systems from Equation 16, AMPeRRe provides a histogram displaying the proportional frequency for which specific fuel-based dispatchable power sources are operating during the measured period.

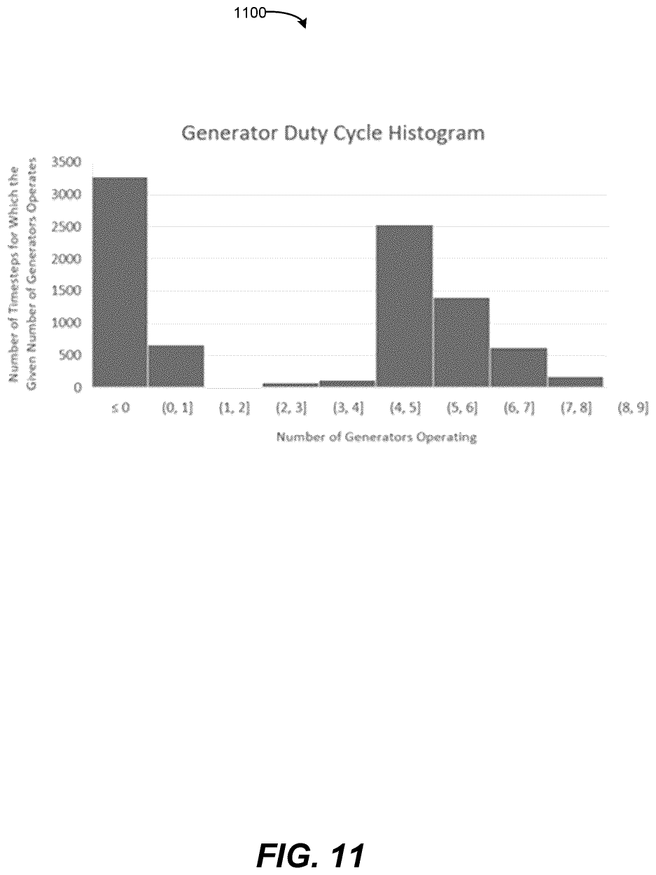

FIG. 11 is a histogram chart 1100 of generators operating, according to an example. The rate of fuel consumption is dependent on fuel-based power source output D[t] and the set of fuel-based power sources operating Gₒ[t]. In generator model specifications, for example, fuel consumption curves define the rate of fuel consumption at different power outputs. Depending on the shape of the fuel consumption curve, AMPeRRe models a linear or non-linear formula as a best-fit to the curve to mathematically define the relationship between power output and rate of fuel consumption. If the best-fit fuel consumption curve model is linear, it is represented by Equation “a” in set 26. If the model is quadratic, it is represented by equation “b” or “c.” Coefficients a, b, c, and d are associated with the best-fit curve specific to the fuel consumption curve(s) evaluated.

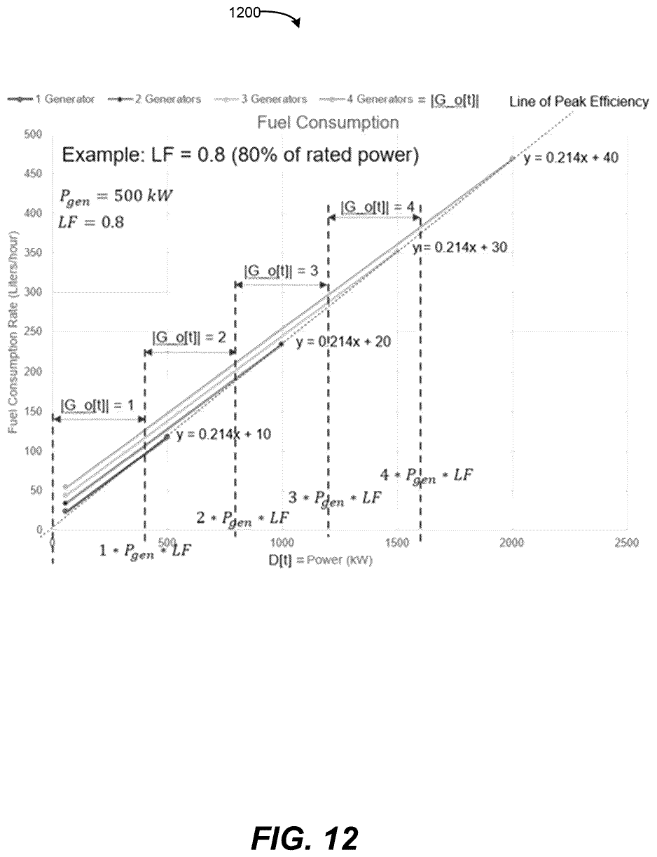

In a system with multiple generators of the same model, the fuel consumption curve and coefficients are the same for each generator. Equation set 25 represents the fuel consumption of this system and the number of generators running is represented by |Gₒ[t]|. FIG. 12 shows an example of how the power output demanded of the generator set and the number of generators operating impact the overall fuel consumption rate at any given time. The y-intercept of the fuel consumption curve shifts and the collective rated power changes depending on how many generators within a system are operating. The number of generators operating is dependent on the power output demanded of the generator set D[t], so the vertical dashed-line overlay provides an example of the number of generators that would operate depending on the x-axis power output.

$$\begin{matrix}\begin{matrix}Equation Set 25 : Fuel Consumption Curve \\ Models for a Set of Same - Model Generators\end{matrix} & \\ F [ t ] = aD [ t ] + b \vert {G}_{o} [ t ] \vert & ( 25 a )\end{matrix}$$

$$F [ t ] = {aD [ t ]}^{2} + bD [ t ] + c \vert {G}_{o} [ t ] \vert \qquad ( 25 b )$$

$$F [ t ] = {aD [ t ]}^{3} + {bD [ t ]}^{2} + cD [ t ] + d \vert {G}_{o} [ t ] \vert \qquad ( 25 c )$$

FIG. 12 is a chart 1200 illustrating a fuel consumption rate curve dependent on the set of generators operating, according to an example. In a system with multiple generators of various models, Equation set 26 represents the fuel consumption curve summation of the system. Each model may have a different fuel consumption curve and different coefficients, so the fuel consumption curve of each individual generator in the set is factored into this calculation.

$$\begin{matrix}\begin{matrix}Equation Set 26 : Fuel Consumption Curve \\ Models of a Multi - Generator System\end{matrix} & \\ F [ t ] = {\sum }_{i ∈ {G}_{o} [ t ]} {a}_{i} \frac{D [ t ] * {P}_{gen , i}}{{\sum }_{j ∈ {G}_{o} [ t ]} {P}_{gen , j}} + {b}_{i} & ( 26 a )\end{matrix}$$

$$F [ t ] = {\sum }_{i ∈ {G}_{o} [ t ]} {{a}_{i} ( \frac{D [ t ] * {P}_{gen , i}}{{\sum }_{j ∈ {G}_{o} [ t ]} {P}_{gen , j}} )}^{2} + {b}_{i} \frac{D [ t ] * {P}_{gen , i}}{{\sum }_{j ∈ {G}_{o} [ t ]} {P}_{gen , j}} + {c}_{i} \qquad ( 26 b )$$

$$F [ t ] = {\sum }_{i ∈ {G}_{o} [ t ]} {{a}_{i} ( \frac{D [ t ] * {P}_{gen , i}}{{\sum }_{j ∈ {G}_{o} [ t ]} {P}_{gen , j}} )}^{3} + {{b}_{i} ( \frac{D [ t ] * {P}_{gen , i}}{{\sum }_{j ∈ {G}_{o} [ t ]} {P}_{gen , j}} )}^{2} + {c}_{i} \frac{D [ t ] * {P}_{gen , i}}{{\sum }_{j ∈ {G}_{o} [ t ]} {P}_{gen , j}} + {d}_{i} \qquad ( c )$$

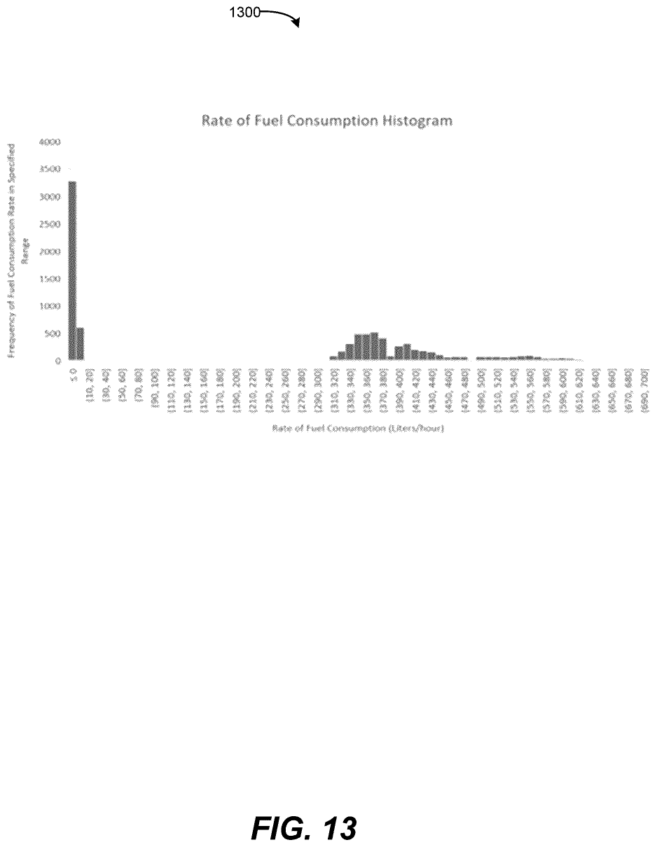

FIG. 13 is a chart 1300 illustrating a rate of fuel consumption histogram, according to an example. Using the fuel consumption dataset F [t], AMPeRRe provides a histogram that shows the comparative frequency of the system's fuel consumption rate at any given time.

Forecasting a site's fuel consumption can provide insights about several aspects of its operation. Reduced fuel consumption leads to reduced costs, noise, and greenhouse gas emissions. Fuel use requires transport, so the more fuel a site uses, the more frequently it must import fuel and allocate fuel to the transport process itself. If the site knows its current fuel consumption, AMPeRRe results can derive the fuel savings associated with changes in power grid renewable sources or energy storage. If the site knows their current time needed between fuel resupply, AMPeRRe results can inform the site of their projected change in time between resupply associated with power grid changes. Equation 27 assumes an inverse relationship between the time between resupply and the fuel consumption rate. Fₜₒₜₐₗ is the current fuel consumption rate while F′ₜₒₜₐₗ is the rate found by AMPeRRe for the new scenario. “t_{resupply}” represents the current amount of time between fuel resupply.

$$\begin{matrix}\begin{matrix}Equation 27 : Time Between Fuel Resupply given a \\ Known Change in Fuel Consumption Rate\end{matrix} & \\ {t}_{resupply}^{′} = \frac{{F}_{total}}{{F}_{total}^{′}} * {t}_{resupply} & ( 27 )\end{matrix}$$

If the site knows its available fuel storage capacity, AMPeRRe can calculate the time needed between fuel resupply using fuel consumption rate and this known capacity. C_{fuel} represents the fuel storage capacity in Equation 28.

$$\begin{matrix}\begin{matrix}Equation 28 : Time Between Fuel Resupply \\ given a Known Fuel Storage Capacity\end{matrix} & \\ {t}_{resupply}^{′} = \frac{{C}_{fuel}}{{F}_{total}^{′}} & ( 28 )\end{matrix}$$

The following relates to resilience to solar or wind failure. AMPeRRe forecasts the power availability, fuel consumption, and excess energy of a system given known rated quantities of each solar array, wind turbine, fuel-based dispatchable source, and energy storage system. This model maintains an assumption that these resources are fully functional throughout the measured time period, but it is also capable of deviating from this assumption to model the disconnection or loss of any combination of resources for a specified amount of time. For solar arrays, AMPeRRe can model the loss of a proportion of the rated power. For wind and fuel-based resources, AMPeRRe can model the loss of specific units. Assuming the total energy storage capacity is distributed between multiple energy storage systems, AMPeRRe can model the loss of any proportion of the total capacity.

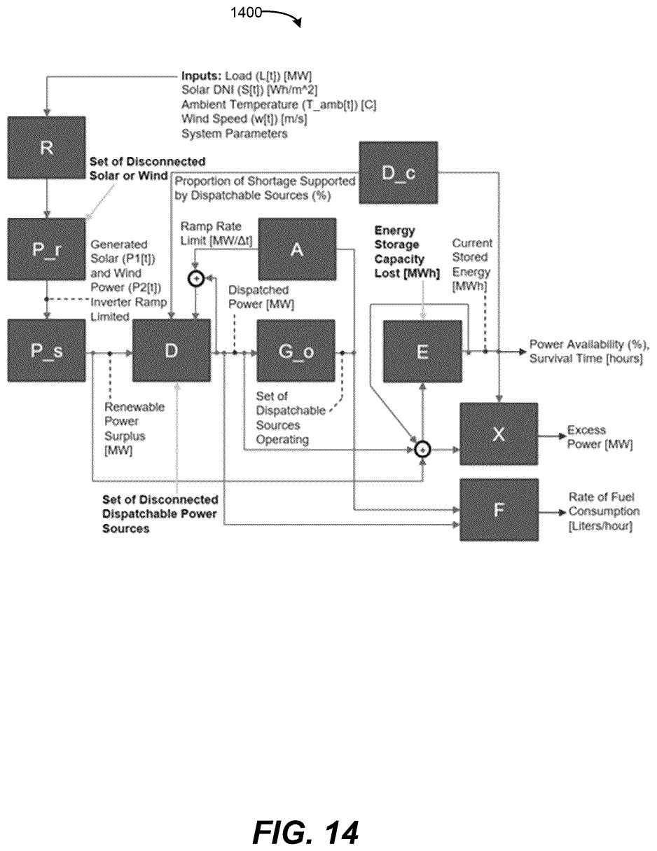

FIG. 14 is a block diagram 1400 with disturbance signals to model power resource losses. The rated solar power input is a constant, but Equation 29 presents another input variable c_{1,failed} to model any chosen set of solar array losses and calculate the available solar power at each timestep. If this resource loss condition is set, Equation 29 shows that the set of solar arrays operating c₁ [t] loses the items selected in c_{1,failed} for the specified time period tₛᵢ₁ to tₛᵢ₂. The set c₁[t] factors into Equation 1 to calculate the generated PV solar power at every timestep.

$$\begin{matrix}Equation 29 : Set of Solar Arrays Operating & \\ {c}_{1} [ t ] = [ 1 ... i ] - {c}_{1 , failed} for \vert {c}_{1 , failed} \vert > 0 and & ( 29 )\end{matrix}$$

$${t}_{si 1} < t < {t}_{si 2} else {c}_{1} [ t ] = [ 1 ... i ]$$

The loss of installed solar power will reduce its generated power during the associated time period, so greater shortages will exist between renewable power generation and the load. Dispatchable sources must supply a greater proportion of power to fulfill the load in this scenario, and more fuel is consumed during this period. If adequate dispatchable power exists, the loss of solar is unlikely to have an impact on power availability. The less dispatchable power within the system and the greater the associated solar power shortage, the more likely the loss of solar is to result in a loss of power service.

AMPeRRe users can model the power curve of each wind turbine, calculate generated power at each timestep from each turbine, and sum the individual entities to calculate the collective generated wind power. Loss of wind power is modeled by omitting the disconnected turbines from the set of operating turbines used in the Equation 4 summation. Equation 30 represents the set of operating wind turbines considering any user-defined turbine losses. Similar to solar power loss, the loss of wind power will increase the shortage between renewable power and the load. This causes any fuel-based dispatchable sources to contribute a greater proportion of power and consume more fuel during the time period of loss.

$$\begin{matrix}Equation 30 : Set of Wind Turbines Operating & \\ {c}_{2} [ t ] = [ 1 ... i ] - {c}_{2 , failed} for \vert {c}_{2 , failed} \vert > 0 and & ( 30 )\end{matrix}$$

$${t}_{wi 1} < t < {t}_{wi 2} else {c}_{2} [ t ] = [ 1 ... i ]$$

The following relates to resilience to failures of dispatchable power sources or energy storage. The set of fuel-based dispatchable sources supporting the system is a user-input constant, but AMPeRRe allows the modeled loss of some or all these sources within a specified time period. Similar to the loss of wind turbines or solar arrays, the loss of individual generators would cause their power contribution to be subtracted from the total rated generator power and limit the power (D[t]) the set of generators can provide. The set of generators operating Gₒ[t] is limited to the available generators during the period of generator loss. Fuel consumption is also affected during this generator failure, as the number of generators operating and power output both impact the rate of fuel consumption at each timestep.

$$\begin{matrix}\begin{matrix}Equation 31 : Set of Generators Available with Generator Loss\end{matrix} & \\ {G}_{a} [ t ] = [ 1 ... n ] - {G}_{a , failed} for \vert {G}_{a , failed} \vert > 0 and & ( 31 )\end{matrix}$$

$${t}_{gi 1} < t < {t}_{gi 2} else {G}_{a} [ t ] = [ 1 ... n ]$$

AMPeRRe can model the loss of a proportion of the energy storage capacity. The greater the loss and the lower the remaining stored energy, the less these energy storage systems can capture excess renewable energy during the period of loss. This creates the need for more excess energy management and dispatchable power involvement. Fuel-based dispatchable sources will consume more fuel in this state. If the remaining energy storage capacity (E_{cap,input}−E_{cap,loss}) is lower than any defined reserve energy quantity (E_{reserve,i}), dispatchable power will be continuously involved.

$$\begin{matrix}Equation 32 : Energy Storage Capacity Available with Capacity Loss & \\ {E}_{cap} [ t ] = {E}_{cap , input} - {E}_{cap , loss} for {t}_{b 1} < t < {t}_{b 2} & ( 32 )\end{matrix}$$

$$else {E}_{cap} [ t ] = {E}_{cap , input}$$

Dispatchable sources of power such as generators support the renewables during periods of shortage, so dispatchable source failures are most likely to cause loss of power service. If a system has full power availability during business-as-usual conditions, it may lose power availability during a time period of dispatchable resource loss (t_{g1}<t<t_{g2}). Equation 33 calculates survival time, or the time from the start of any resource loss to the loss of power service. t₁ is the moment of failure, while tₗₒₛₛ is the first timestep at which the stored energy reaches zero and the system loses power service.

$$\begin{matrix}\begin{matrix}Equation 33 : Survival Time - Elapsed Time from \\ Start of Failure to Loss of Power Service\end{matrix} & \\ {t}_{survival} = {t}_{loss} - {t}_{1} for {t}_{survival} \leq {t}_{2} - {t}_{1} else {t}_{survival} = N / A & ( 33 )\end{matrix}$$

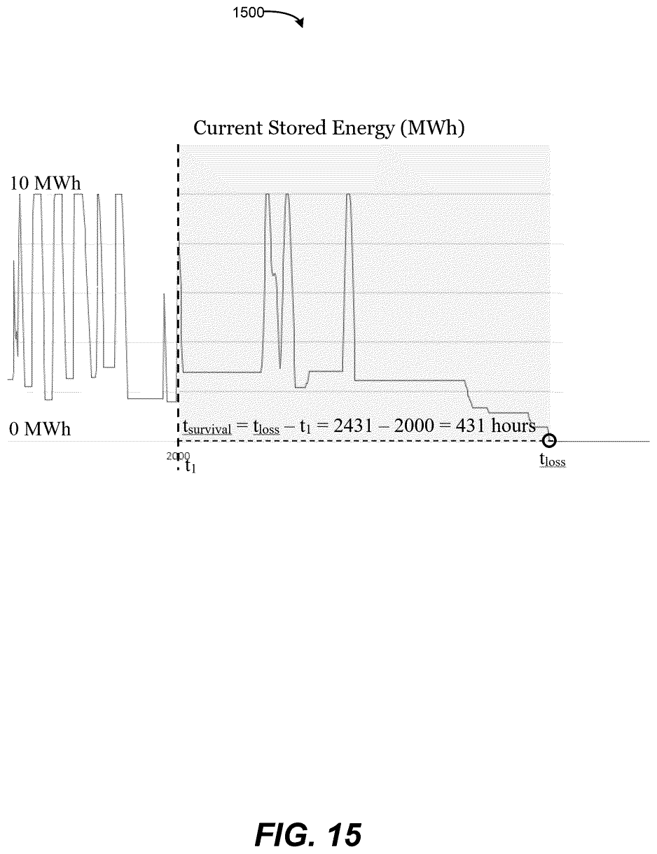

FIG. 15 is a chart 1500 of visualized depletion of stored energy for a loss of six out of 10 generators and eight out of 10 MW in a solar array, as well as calculated survival time, according to an example. This calculation process often yields a survival time resulting from dispatchable power source losses, but it also calculates survival time for failures of solar, wind, and energy storage sources. AMPeRRe can simultaneously model each of these resource losses, and the time periods of each loss are variables independent of each other. While the loss of solar, wind, and energy storage are less likely to cause a loss of power service, each of these losses shorten the survival time associated with dispatchable source failure.

The following relates to fuel-based source power output considerations. By default, AMPeRRe assumes that the operating generators share the load evenly proportionate to size and applies this assumption to every calculation. This mode of operation prevents complications associated with two scenarios:
A. Prolonged Operation at Full Rated Power:
   Causes strain and reduces generator lifespan
   Limits the capability of individual generators to respond to sudden load spikes
B. Operation at Low Power Relative to Rated Power:
   Is an inefficient mode of operation due to mechanical friction
   May cause wet stacking, a buildup of unburned fuel at the exhaust side of the generator. This occurrence can cause a loss of performance and significantly reduce generator lifespan.

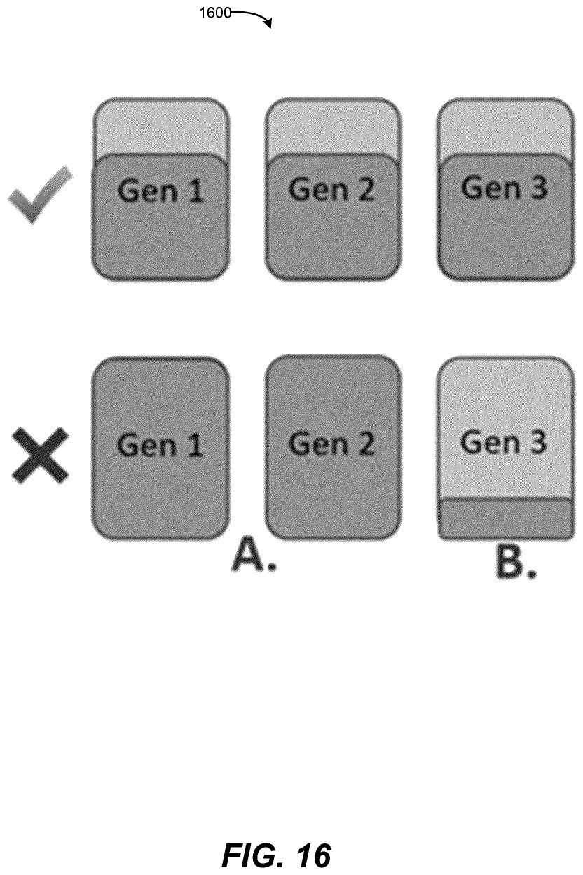

FIG. 16 is a diagram 1600 of ideal vs non-ideal load-sharing between generators, according to an example. By modeling a generator control system that avoids these two extremes, AMPeRRe assumes that generators operate at a proportion of their rated power that maximizes fuel efficiency and promotes long generator life. Manufacturer fuel consumption curves define the rate of generator fuel consumption dependent on its power output. The overall fuel consumption is also dependent on the number of generators operating, as each additional generator adds friction to the system. This shifts the power curve upwards and is accounted for in the AMPeRRe algorithm.

AMPeRRe uses Equations 22 and 23 to calculate the excess energy of a power system during a specified time period. Excess energy is often managed through curtailment, filtered out, or sold to the utility if the power grid is utility-connected. Curtailment is an intentional shut-off of power generation systems to control input power. If input power exceeds load enough to overwhelm storage and other input power control systems, curtailment may be necessary. Several factors influence the decision to curtail power (Bird 2014). Particularly in wind applications, one of the greatest reasons for curtailment is transmission constraints. When the development of additional renewable energy sources outpaces the development of transmission lines to transport the generated energy, curtailment is implemented to protect this transmission. System balancing may also be a challenge that requires curtailment in the scenario that input power exceeds load, storage sources, and other power routes. Voltage, interconnection, and stability issues are also prevalent causes of curtailment.

Embodiments of AMPeRRe not only forecast present term power outcomes such as availability, survival time, and fuel consumption of a proposed power grid, but are also capable of projecting future outcomes. With climate condition projections and load-change models incorporated in AMPeRRe's process, AMPeRRe can be prompted to make probabilistic determinations of these power outcomes for a chosen number of years into the future.

Load, wind speed, solar irradiance, and ambient temperature data inputs may not experience the same patterns long-term due to population growth, electric demand changes, the progression of climate change and other factors. Time-based growth formulas based on predictive models are applied to each of these input data sets to forecast the change these variables will experience over a given number of years. This informs subsequent calculations of power availability, resilience, and fuel consumption that are accurate to a chosen future time period.

The following table presents a summary of formulas that the embodiments of AMPeRRe use:

TABLE 2
Summary of AMPeRRe Formulas

| | |
|---|---|
| PV Solar Generated Power | Efficiency Representing Loss due to Temperature |
| R₁[t] = Σ [symbol] C [symbol] * S[t] * n_{loss,i}[t] * e_{inverter,i} | Increase |
| | nₗₒₛₛ[t] = 1 − λ(T_{cell}[t] − 25) ≤ 1 |
| | else nₗₒₛₛ[t] = 1 |
| Temperature of the PV Cells | Wind Turbine Power Curve Mathematical Model |
| ${T}_{cell} [ t ] = {T}_{amb} [ t ] + ( \frac{S [ t ]}{800} * ( \text{?} - 20 ) )$ | ${R}_{2} [ t ] = \text{?} \frac{{C}_{2 , i}}{( 1 + {a}_{i} \text{?} )}$ |
| Solar or Wind Power with Inverter Ramp Limits | Inverter Ramp Rate Limit on Solar or Wind Power |
| Pⱼ[t] = Rⱼ[t] for Pⱼ[t − 1] − Σ [symbol] R_{rampdown,i} < | Pⱼ[t] = Pⱼ[t − 1] + Σ [symbol] R_{rampup,i} for |
| ΔRⱼ[t] < Pⱼ[t − 1] + Σ [symbol] R_{rampup,i} | Rⱼ[t] − Pⱼ[t − 1] > Pⱼ[t − 1] + Σ [symbol] R_{rampup,i} |
| | Pⱼ[t] = Pⱼ[t − 1] − Σ [symbol] R_{rampdown,i} for |
| | Rⱼ[t] − Pⱼ[t − 1] < Pⱼ[t − 1] − Σ [symbol] R_{rampdown,i} |
| Total Renewable Power | Surplus of Renewable Power (W) |
| Pᵣ[t] = P [symbol] [t] + P [symbol] [t] | P [symbol] [t] = Pᵣ[t] + L[t] |
| Dispatchable Power Provided to System (W) | Input Tiers of Dispatchable Power Support |
| D[t] = Dₑ[t] + \|P [symbol] [t]\| for | d = [d [symbol] . . . dₚ] |
| D[t − 1] − A[t] < D[t] − D[t − 1] < | Eᵣₑₛₑᵣᵥₑ = [E_{reserve,0} . . . E_{reserve,p}] |
| D[t − 1] + A[t] and D[t] ≤ Σ [symbol] P_{gen,i} | |
| Conditions of Dispatchable Source Support | Collective Generator Acceptance Rate |
| D [symbol] [t] = dᵢ for P [symbol] [t] < 0 and E_{reserve,j-1} ≤ | $A [ t ] = \text{?}$ |
| E[t] < E_{reserve,j} else D [symbol] [t] = 0 | |
| 1 ≤ i ≤ p and 0 ≤ dᵢ ≤ 1 | |
| E_{reserve,0} = 0 | |
| Acceptance Rate Limit on Dispatchable Power | Set of Generators Operating |
| D[t] = D[t − 1] + A[t] for | Gₒ[t] = [∅] for D[t] = 0 else |
| ΔD[t] > D[t − 1] + A[t] | Gₒ[t] = [1 . . . k[t]] ∈ G [symbol] [t] |
| D[t] = D[t − 1] − A[t] for | k[t] = min(i ∈ G [symbol] [t]) for which |
| ΔD[t] < D[t − 1] − A[t] | $\text{?} {P}_{gen , i} \geq \frac{D [ t ]}{LF} while \vert \text{?} [ t ] \vert \leq \vert \text{?} [ t ] \vert$ |
| Stored Energy/State of Charge (Wh) | Charge Rate Limit on State of Charge |
| E[0] = E_{reserve,1} | E[t] = E[t − 1] + R_{charge} for |
| E[t] = P [symbol] [t] + D[t] + E[t − 1] | P [symbol] [t] + D[t] > R_{charge} else |
| for 0 ≤ E[t] ≤ E_{cap} | E[t] = Min(E_{cap} · P [symbol] [t] + D[t] + E[t − 1] |
| E[t] = 0 for E[t] < 0 and | |
| E[t] = E_{cap}[t] for E[t] > E_{cap}[t] | |
| Discharge Rate Limit on State of Charge | Power Availability (%) |
| E[t] = E[t − 1] − R_{discharge} for P [symbol] [t] + D[t] < R_{discharge} else | $S = \frac{100}{{t}_{total}} * \text{?} \begin{matrix}( 1 for ( E [ {t}_{i} ] > 0 or \\ {P}_{z} [ {t}_{i} ] + D [ {t}_{i} ] \geq 0 ) else 0 )\end{matrix}$ |
| E[t] = Max(0, P [symbol] [t] + D[t] + E[t − 1]) | |
| Excess Power due to Lack of Available Energy | Excess Power due to Insufficient Allowable |
| Storage Capacity | Charge Rate |
| X₁[t] = (P [symbol] [t] + D[t] + E[t − 1]) − E_{cap} for | X₂[t] = (P [symbol] [t] + D[t]) − R_{charge} for |
| E[t] = E_{cap} else X₁[t] = 0 | P [symbol] [t] + D[t] > R_{charge} else X₂[t] = 0 |
| Total Excess Power | Linear and Quadratic Fuel Consumption Curve |
| X[t] = X₁[t] + X₂[t] | Models for a Set of Same-Model Generators |
| | F[t] = aD[t] + b\|Gₒ[t]\| [symbol] |
| | F[t] = aD[t]² + bD[t] + c\|Gₒ[t]\| [symbol] |
| | F[t] = aD[t]² + bD[t]² + cD[t] + d\|Gₒ[t]\| [symbol] |

Fuel Consumption Curve Models for a Mulli-Generator System
$F [ t ] = \text{?} {a}_{i} \frac{D [ t ] * {P}_{gen , i}}{\text{?}} + {b}_{i}$
$F [ t ] = \text{?} {a}_{i} ( \frac{D [ t ] * {P}_{gen , i}}{\text{?}} \text{?} + {b}_{i} \frac{D [ t ] * {P}_{gen , i}}{\text{?}} + {c}_{i}$
$F [ t ] = \text{?} {a}_{i} ( \frac{D [ t ] * {P}_{gen , i}}{\text{?}} \text{?} + {b}_{i} ( \frac{D [ t ] * {P}_{gen , i}}{\text{?}} \text{?} + {c}_{i} \frac{D [ t ] * {P}_{gen , i}}{\text{?}} + {d}_{i}$

| | |
|---|---|
| Time Between Fuel Resupply given a Known | Time Between Fuel Resupply given a Known Fuel |
| Change in Fuel Consumption over Time | Storage Capacity |
| ${t}_{resupply}^{′} = \frac{{F}_{total}}{{F}_{total}^{′}} * {t}_{resupply}$ | ${t}_{resupply}^{′} = \frac{{C}_{fuel}}{{F}_{total}^{′}}$ |
| Survival Time - Elapsed Time from Start of | Proportion of Load Supplied by Renewables |
| Failure to Loss of Power Service tₛᵤᵣᵥᵢᵥₐₗ = tₗₒₛₛ − t₁ for tₛᵤᵣᵥᵢᵥₐₗ ≤ | ${P}_{VRE} [ t ] = 1 - \frac{\vert {P}_{s} [ t ] \vert}{L [ t ]} for$ |
| t₂ − t₁ else tₛᵤᵣᵥᵢᵥₐₗ = N/A | P [symbol] [t] < 0 else P_{VRE}[t] = 1 |
| Set of Solar Arrays Operating | Set of Wind Turbines Operating |
| c₁[t] = [1 . . . i] − c_{1,failed} for \|c_{1,failed}\| < | c₂[t] = [1 . . . i] − c_{2,failed} for \|c_{2,failed}\| > |
| 0 and t [symbol] < t < t [symbol] else c₁[t] = [1 . . . i] | 0 and t_{wi1} < t < t_{wi2} else c₂[t] = [1 . . . i] |
| Set of Generators Available with Generator Loss | Energy Storage Capacity Available with Loss |
| Gₐ[t] = [1 . . . n] − G_{a,failed} for \|G_{a,failed}\| > 0 | E_{cap}[t] = E_{cap,input} − E_{cap,loss} for E_{cap,loss} > 0 |
| and t [symbol] < t < t [symbol] else Gₐ[t] = [1 . . . n] | and t_{b1} < t < t_{b2} else E_{cap}[t] = E_{cap,input} |

[symbol]

indicates data missing or illegible when filed

The following is a list of variables that the embodiments of AMPeRRe use, presented first in alphabetical order, and presented again in order of use:

### Variables (Alphabetical Order)

A[t]=Collective generator acceptance rate (KW/Δt)
a, b, c, d=Fuel consumption curve mathematical model coefficients
c₁[t]=Set of operating solar arrays (varies as conditions change over time)
c_{1,failed}=User-input set of failed solar arrays
C₁=Rated power of a solar array
C₂[t]=Set of operating wind turbines (varies as conditions change over time)
c_{2,failed}=User-input set of failed wind turbines
C₂=Rated power of a wind turbine
C_{fuel}=Fuel storage capacity (L)
d=Set of dispatchable power support tiers—proportions of shortage support that are dependent on stored energy/state of charge
dᵢ=One dispatchable power support tier—a proportion of shortage support that applies when the stored energy is within a defined range
D[t]=Dispatchable power provided to system
D_{c}[t]=Proportion of power shortage supported by dispatchable sources at any given time
E[t]=Current stored energy/state of charge
eᵢₙᵥₑᵣₜₑᵣ=Efficiency of the inverter for a solar array
Eᵣₑₛₑᵣᵥₑ=Set of reserve energy thresholds—different quantities of energy storage that act as boundary conditions for which certain dispatchable power support proportions are applied
E_{reserve,j}=One reserve energy threshold—a quantity of energy storage that acts as a boundary condition for which a different dᵢ value applies when surpassed
F[t]=Rate of fuel consumption vs time
E_{cap}[t]=Energy storage capacity (kWh)
E_{cap,input}=User-input collective energy storage capacity
E_{cap,loss}=User-input quantity of energy storage capacity loss
Fₜₒₜₐₗ=Total fuel consumed during measured period-baseline scenario (L)
F′ₜₒₜₐₗ=Total fuel consumed during measured period-new scenario (L)
Gₐ[t]=Set of available generators considering generator loss at specific time(s)
G_{a,failed}=User-input set of failed generators
Gₒ[t]=Set of generators operating
k[t]=The final value in the set of operating generators, or the integer representing the last operating generator in the set of operating generators
k=Second wind turbine model coefficient—rate of power increase with wind speed
L[t]=User-input load profile
LF=Load factor—the proportion of generator rated power at which, when surpassed, the next generator in the set of available generators is activated
nₗₒₛₛ[t]=Efficiency loss due to temperature increase in solar array
p=Number of tiers of dispatchable power source support
P₁[t]=PV solar generated power with inverter ramp limits
P₂[t]=Wind turbine generated power with inverter ramp limits
Pᵣ[t]=Total renewable power provided at any given time
Pₛ[t]=Surplus of renewable power at any given time
P_{gen,i}=Rated power of one generator
P_{VRE}[t]=Proportion of load supplied by renewables
R₁[t]=PV solar generated power
R₂[t]=Wind turbine power curve mathematical model—power generated from wind farm
R_{charge}=Maximum energy storage system charge rate
R_{discharge}=Maximum energy storage system discharge rate
R_{gen,i}=Power acceptance rate of one generator
R_{rampdown}=Maximum inverter ramp-up rate
Rᵣₐₘₚᵤₚ=Maximum inverter ramp-up rate
S=Power availability (%)
S[t]=User-input direct normal solar irradiance data
t=Time (h)
t₁=The start time of a modeled power resource failure
t₂=The end time of a modeled power resource failure
T_{amb}[t]=User-input ambient temperature vs time data
t_{b1}=Start time of energy storage capacity failure
t_{b2}=End time of energy storage capacity failure
T_{cell} [t]=Temperature of the PV cells in a solar array
t_{g1}=Start time of generator failure
t_{g2}=End time of generator failure
tₗₒₛₛ=The time at which power loss occurs after a power resource failure
T_{NOCT}=Nominal operating cell temperature
t_{resupply}=Time between fuel resupply—baseline scenario
t′_{resupply}=Time between fuel resupply—new scenario
tₛ₁=Start time of solar array failure
tₛ₂=End time of solar array failure
tₛᵤᵣᵥᵢᵥₐₗ=Survival time—elapsed time from start of failure to loss of power service
tₜₒₜₐₗ=Total number of timesteps in evaluated time period
t_{w1}=Start time of wind turbine failure
t_{w2}=End time of wind turbine failure
w[t]=User-input wind speed vs time data
X[t]=Total excess power
X₁[t]=Excess power due to lack of available energy storage capacity
X₂[t]=Excess power due to insufficient allowable charge rate
λ=Solar cell model temperature coefficient

### Variables (Order of Use)

t=Time (h)
R₁[t]=PV solar generated power
C₁=Rated power of a solar array
S[t]=User-input direct normal solar irradiance data
nₗₒₛₛ [t]=Efficiency loss due to temperature increase in solar array
eᵢₙᵥₑᵣₜₑᵣ=Efficiency of the inverter for a solar array
c₁[t]=Set of operating solar arrays (varies as conditions change over time)
λ=Solar cell model temperature coefficient
T_{cell} [t]=Temperature of the PV cells in a solar array
T_{amb}[t]=User-input ambient temperature vs time data
T_{NOCT}=Nominal operating cell temperature
R₂[t]=Wind turbine power curve mathematical model-power generated from wind farm
C₂=Rated power of a wind turbine
a=Coefficient for wind turbine power curve mathematical model
k=Second coefficient-rate of power increase with wind speed
w[t]=User-input wind speed vs time data
c₂[t]=Set of operating wind turbines (varies as conditions change over time)
P₁[t]=PV solar generated power with inverter ramp limits
P₂[t]=Wind turbine generated power with inverter ramp limits
Rᵣₐₘₚᵤₚ=Maximum inverter ramp-up rate
R_{rampdown}=Maximum inverter ramp-up rate
Pᵣ[t]=Total renewable power provided at any given time
L[t]=User-input load profile
Pₛ[t]=Surplus of renewable power at any given time
D[t]=Dispatchable power provided to system
D_{c}[t]=Proportion of power shortage supported by dispatchable sources at any given time
A[t]=Collective generator acceptance rate (KW/Δt)
P_{gen,i}=Rated power of one generator
Gₐ[t]=Set of available generators considering generator loss at specific time(s)
d=Set of dispatchable power support tiers—proportions of shortage support that are dependent on stored energy/state of charge
dᵢ=One dispatchable power support tier—a proportion of shortage support that applies when the stored energy is within a defined range
Eᵣₑₛₑᵣᵥₑ=Set of reserve energy thresholds—different quantities of energy storage that act as boundary conditions for which certain dispatchable power support proportions are applied
Eᵣₑₛₑᵣᵥₑ j=One reserve energy threshold—a quantity of energy storage that acts as a boundary condition for which a different dᵢ value applies when surpassed
E[t]=Current stored energy/state of charge
p=Number of tiers of dispatchable power source support
R_{gen,i}=Power acceptance rate of one generator
Gₒ[t]=Set of generators operating
k[t]=The final value in the set of operating generators, or the integer representing the last operating generator in the set of operating generators
LF=Load factor—the proportion of generator rated power at which, when surpassed, the next generator in the set of available generators is activated
E_{cap}[t]=Energy storage capacity (kWh)
R_{charge}=Maximum energy storage system charge rate
R_{discharge}=Maximum energy storage system discharge rate
S=Power availability (%)
tₜₒₜₐₗ=Total number of timesteps in evaluated time period
X₁[t]=Excess power due to lack of available energy storage capacity
X₂[t]=Excess power due to insufficient allowable charge rate
X[t]=Total excess power
F[t]=Rate of fuel consumption vs time
a, b, c, d=Fuel consumption curve mathematical model coefficients
t_{resupply}=Time between fuel resupply—baseline scenario
Fₜₒₜₐₗ=Total fuel consumed during measured period—baseline scenario (L)
t′_{resupply}=Time between fuel resupply-new scenario
F′ₜₒₜₐₗ=Total fuel consumed during measured period—new scenario (L)
C_{fuel}=Fuel storage capacity (L)
tₛᵤᵣᵥᵢᵥₐₗ=Survival time—elapsed time from start of failure to loss of power service
tₗₒₛₛ=The time at which power loss occurs after a power resource failure
t₁=The start time of a modeled power resource failure
t₂=The end time of a modeled power resource failure
P_{VRE}[t]=Proportion of load supplied by renewables
c_{1,failed}=User-input set of failed solar arrays
tₛ₁=Start time of solar array failure
tₛ₂=End time of solar array failure
c_{2,failed}=User-input set of failed wind turbines
t_{w1}=Start time of wind turbine failure
t_{w2}=End time of wind turbine failure
G_{a,failed}=User-input set of failed generators
t_{g1}=Start time of generator failure
t_{g2}=End time of generator failure
E_{cap,input}=User-input collective energy storage capacity
E_{cap,loss}=User-input quantity of energy storage capacity loss
t_{w1}=Start time of energy storage capacity failure
t_{w2}=End time of energy storage capacity failure

To produce a set of example results, AMPeRRe was used to evaluate a case study of a real Military Installation that is connected to the utility and has backup generators on base. This installation aims to incorporate a 10 MW solar array and supporting energy storage. The following AMPeRRe results forecast outcomes such as fuel savings, excess energy, and utility peak-shaving capability that would result from incorporating different quantities of solar energy and energy storage at the installation. It also explores the differences in these outcomes from operating in a utility-connected vs islanded state, and the survival time after different quantities of generator loss. Installation-specific details are omitted.

A 43-hour utility outage is modeled in AMPeRRe to emulate the baseline case for this installation. This length of outage produces an AMPeRRe scenario that assumes a number of hours of generator involvement and fuel consumption that are approximately equal to the installation-reported historical generator involvement over the past five years. This 43-hour outage is also present in every subsequent case.

For cases with no renewable power sources, the utility and fuel-based sources maintain the battery charge at full capacity in preparation for any power resource failures. The stored energy can then contribute to the load once the failure occurs before backup generators contribute. The larger the battery capacity, the longer it can discharge after a utility outage and the less the generator has to contribute.

For cases with renewable power, the battery charge at which utility power and generators support the load is significantly lower to allow for the battery to capture as much surplus intermittent renewable power as possible.

The following relates to the installation-specific example of AMPeRRe results. Table 4 shares the results selected from the full set that are most relevant to the stages of development for the example installation's microgrid. Row 1 shows the calculated outcomes associated with its current power system, while each subsequent row showcases the forecasted outcomes for potential incremental stages of development. The forecasting module of AMPeRRe can generate these forecasted outcomes, e.g., as forecasted values for power grid outcomes based on the inputs that are intelligently collected by the input module.

TABLE 4
Selected Data from AMPeRRe Example Results that Show Outcomes for Potential Developments

| | | | | | | | | Fuel | | |
|---|---|---|---|---|---|---|---|---|---|---|
| | | Utility | Solar | Gen. | Gen. | # of | | Savings | Days | Excess |
| Power | Power | energy | energy | energy | duty | gen. | Fuel use | from | Between | energy |
| System/ | Availability | (MWh/ | (MWh/ | (MWh/ | cycle | activations | (liters/ | solar | Fuel | (MWh/ |
| Case | (%) | year) | year) | year) | (%) | per year | year) | (%) | Resupply | year) |
| 1. Current | 100 | 15681 | 0 | 51.74 | 0.5 | 4 | 12502.20 | 0 | 3.5 | 0 |
| case/ | | | | | | | | | | |
| Baseline | | | | | | | | | | |
| 2. Add 10 | 100 | 15681 | 0 | 43.98 | 0.42 | 4 | 10632.63 | 14.95 | 4.1 | 0 |
| MWh | | | | | | | | | | |
| Battery | | | | | | | | | | |
| 3. Add 10 | 100 | 15681 | 40.21 | 11.53 | 0.11 | 4 | 2777.992 | 77.78 | 15.8 | 15950 |
| MW Solar | | | | | | | | | | |
| 4. Add | 100 | 7802.5 | 7918.7 | 11.53 | 0.11 | 4 | 2777.992 | 77.78 | 15.8 | 5956.4 |
| microgrid | | | | | | | | | | |
| controller/ | | | | | | | | | | |
| Integrated | | | | | | | | | | |
| utility | | | | | | | | | | |
| involvement | | | | | | | | | | |
| 5. Add peak | 100 | 5829.9 | 8067.4 | 1835.5 | 35 | 680 | 454526 | 62.74 | 0.187 | 12134 |
| shaving | | | | | | | | | | |
| condition - | | | | | | | | | | |
| 1.25 MW | | | | | | | | | | |
| peak utility | | | | | | | | | | |
| power | | | | | | | | | | |
| 6. Island | 100 | 0 | 8030.5 | 7702.2 | 51.9 | 932 | 1864528 | 50.99 | 0.023 | 5840.0 |
| from utility | | | | | | | | | | |

Current case/Baseline (1): This set of results reflects the current operation of the installation. This installation is primarily supported by utility power, but the on-site generators provide power during utility outages. Data provided by the installation on its historical fuel consumption has enabled AMPeRRe modeling of this current case.

Add 10 MWh Battery (2): Adding Li-ion battery energy storage would allow the storage of energy produced by the utility or generators. It can enable utility peak-shaving and capture excess generator power to allow the generator to output the power aligned with its peak efficiency. This is also a critical step toward implementing intermittent renewables such as a 10 MW solar array. The following AMPeRRe results (after Table 4) show the outcomes of implementing various energy storage capacities. Table 4 considers the case of adding 10 MWh of battery energy storage capacity. The energy storage depletes at the start of the utility outage before the generators contribute, which leads to a drop in fuel consumption from the baseline case.

Add 10 MW Solar (3): Adding the 10 MW solar array to the power resources would allow the installation to offset some of its generator use in the event of the utility outage. When the generators are called on to provide power during an outage, the solar array and battery energy storage can instead take priority and provide as much power as possible before the generators contribute. AMPeRRe's results for this case show that adding the 10 MW solar array along with the battery storage would lead to a 77.78% fuel savings when compared to the baseline case, or the current annual fuel use.

Add a microgrid controller (4): This installation currently relies primarily on utility power. Adding a microgrid controller could allow more optimal use of the on-site solar array and energy storage by prioritizing these resources. As modeled by AMPeRRe in the “Integrated utility involvement” scenario, this system would only draw utility power during periods of solar shortage and collective low battery charge. It would also reduce the overall power drawn from the utility and allow for more peak shaving that lowers utility costs. Table 4 shows that if the installation were to apply this control system, generator involvement would remain approximately the same, but the on-site solar array would fulfill a far greater proportion of the power demand compared to the utility than the previous case.

Add peak shaving condition (5): If reducing utility costs becomes an objective, the installation can apply peak shaving. Table 4 considers a 1.25 MW utility power peak. Applying peak shaving creates regular intervals where the on-site microgrid resources are needed to supply during high power demand. In this case, these resources would be the solar array, battery energy storage, and generators. Since the solar array would be nearly used to its full potential without peak shaving, adding peak shaving does not significantly increase the contribution of the solar array to the load. The generators must instead provide a greater magnitude of power during shortages.

Island from utility (6): If this installation has implemented energy storage, a solar array, and a microgrid controller, the on-site resources will be capable of operating as an islanded system. The last row in Table 4 shows the prospective outcomes of operating as an islanded system full-time. While generator involvement and fuel consumption would be far greater, utility costs would be eliminated.

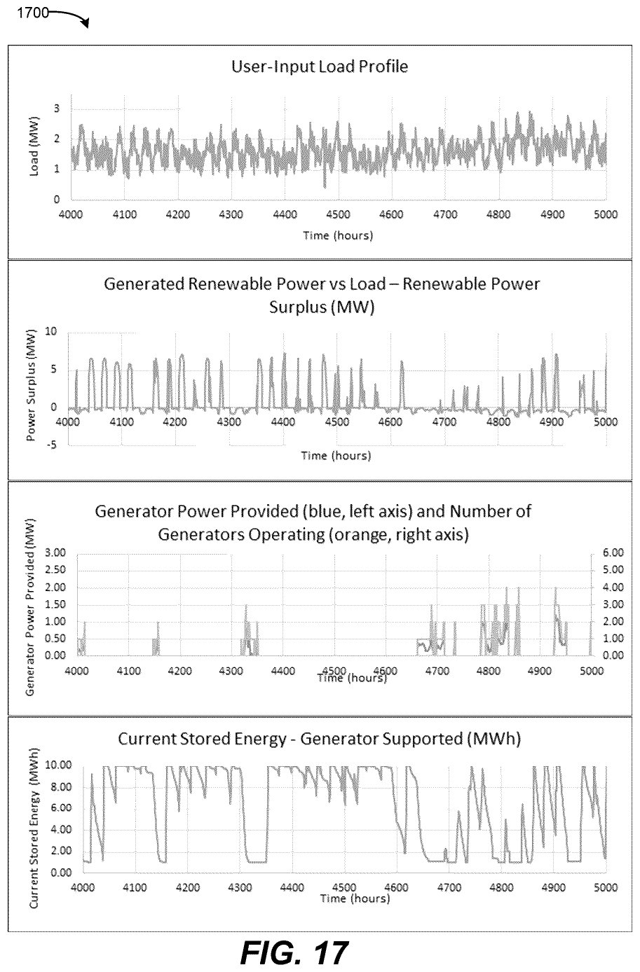

The following presents an example of full numerical and plotted results for an individual scenario. Table 6 shows each of the numerical inputs and results, while FIG. 17 shows an example of a user-input load profile and some of the plotted time-domain dataset outputs.

TABLE 5
Legend for Types of Inputs and Outputs:
Template Key/Guide

Numerical Inputs
Dataset Inputs
Control System Inputs*
Input-Based Assumptions*
Outputs/Forecasted Outcomes
Dataset Outputs

TABLE 6
AMPeRRe Inputs and Example Numerical Results

| | | Peak | Max. | | | | |
|---|---|---|---|---|---|---|---|
| | | Utility | Charge | | | | Total |
| | | Power | for | Utility | Utility | | Energy |
| Total | | Provided | Utility | Outage | Outage | Utility | Provided |
| Energy | | (MW) | to Support | Start | End | Outage | by the |
| Demand | Utility | (peak | Shortage | Time | Time | Duration | Utility |
| (MWh) | Involvement | shaving) | (MWh) | (hour) | (hour) | (hours) | (MWh) |
| 15732.76715 | Primary | 1.25 | #N/A | 690 | 733 | 43 | 10829.55521 |

| | | Solar | Solar | | | | Wind | |
|---|---|---|---|---|---|---|---|---|
| | Quantity | Array | Array | | | Quantity | Turbine | Wind |
| Rated | of Solar | Failure | Failure | Solar | Rated | of Wind | Failure | Turbine |
| Solar | Power | Start | End | Array | Wind | Power | Start | Failure |
| Power | Lost | Time | Time | Failure | Power | Lost | Time | End Time |
| (MW) | (MW) | (hour) | (hour) | Duration | (MW) | (MW) | (hour) | (hour) |
| 10 | 3 | 2000 | 3000 | 1000 | 2.31 | 2.31 | 3500 | 3700 |

| | Proportion | | | Collective | | |
|---|---|---|---|---|---|---|
| | of Total | | | Energy | | Quantity of |
| | Yearly | | | Storage | | Energy |
| Wind | Energy | Collective | Reserve | Charge/ | Average | Storage |
| Turbine | Demand | Energy | Energy | Discharge | State of | Capacity |
| Failure | Supported | Storage | Storage | Rate | Charge | Lost |
| Duration | by Renewables | Capacity | (MWh) | (MW) | (MWh) | (MWh) |
| 200 | 0.17 | 10 | 1 | 5.00 | 7.14 | 0 |

| Energy | Energy | Energy | Collective | | |
|---|---|---|---|---|---|
| Storage | Storage | Storage | Dispatchable | Quantity of | Dispatchable |
| Failure | Failure | Failure | Rated | Dispatchable | Failure |
| Start Time | End Time | Duration | Power | Power | Start Time |
| (hour) | (hour) | (hours) | (MW) | Lost (MW) | (hour) |
| #N/A | #N/A | 0 | 5 | 4 | 6500 |

| | | | Total Duty | | | |
|---|---|---|---|---|---|---|
| | | | Cycle/ | | | |
| | | | Percentage | | | |
| | | | of Time | | Yearly | Yearly Fuel |
| | Dispatchable | | with >0 | Number of | Energy | Consumption - |
| Dispatchable | Failure | Power | Generators | Generator | Produced by | Auto |
| Failure End | Duration | Availability | Operating | Activations/ | Generators | Start/Stop |
| Time (hour) | (hours) | (%) | (%) | Step-ups | (MWh) | (Liters) |
| 7000 | 500 | 99.99 | 10.89 | 240 | 565.79 | 138989.49 |

| | | Fuel | | | |
|---|---|---|---|---|---|
| | Fuel | Consumption | Avg. # of | | Survival |
| Total Hours | Consumption | Savings from | Days | Yearly | Time |
| of Single | Savings from | Storage + | Between | Curtailed | after |
| Generator | Baseline | Renewables | Fuel | Energy | Failure |
| Operation | (%) | (%) | Resupply | (MWh) | (hours) |
| 1835.00 | −1011.72 | 88.55 | 0.314827478 | 10800.91 | 180 |

AMPeRRe provides plotted results to visualize how the renewable power production, dispatchable power, and state of stored energy change throughout the measured time period. These results include frequency-domain plots, including the frequency at which the collective stored energy is at different states. The higher the level of collective stored energy, the more likely the power grid is to maintain power availability during adverse conditions when energy resources fail. The more frequently a grid maintains a high level of stored energy, the more likely it is to be prepared for these adverse events. AMPeRRe also plots the frequency at which fuel-based sources operate at different rates of fuel consumption. One histogram shows the duty cycle of each individual fuel-based dispatchable source specified by the user.

Embodiments described herein can generate (e.g., via a forecasted results generator using the forecasted values from the forecasting module) and include, in a results report, the example results described herein and as illustrated in, e.g., FIG. 17-FIG. 35.

FIG. 17 is a chart 1700 of user-input load profile and plotted time-domain AMPeRRe results, according to an example.

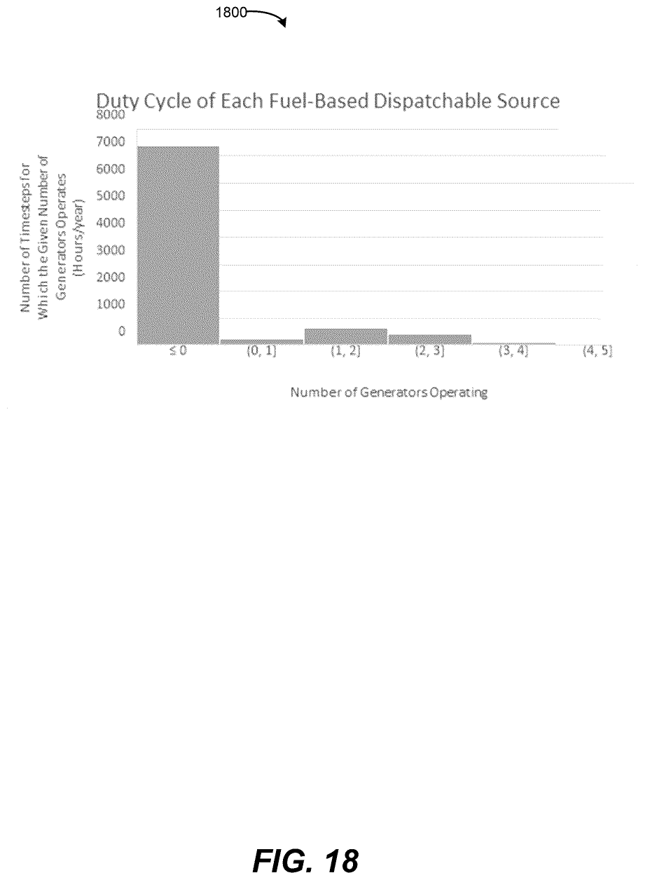

FIG. 18 is a chart 1800 of calculated duty cycle for each dispatchable source (in this example, diesel generators) in a power system, according to an example.

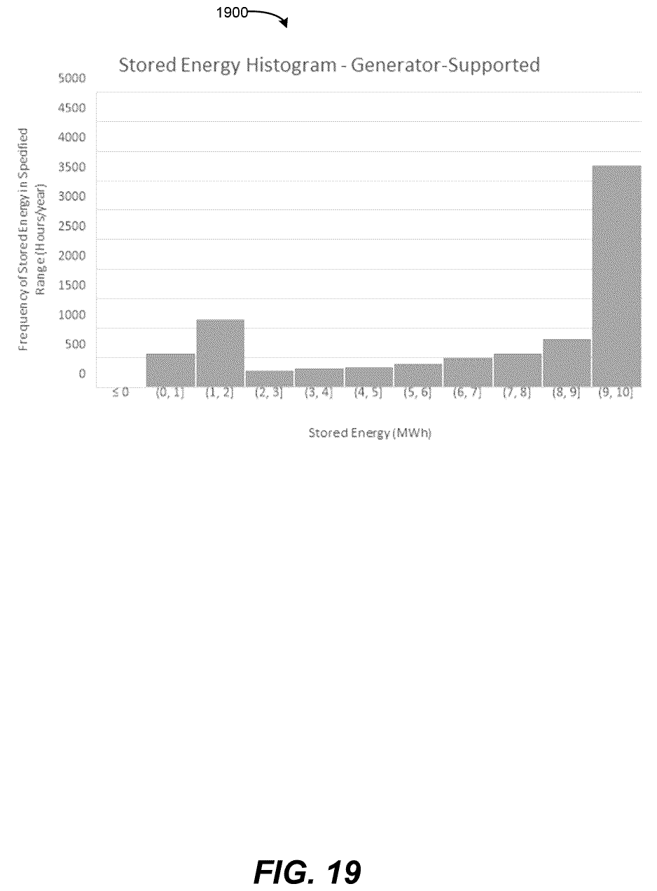

FIG. 19 is a chart 1900 of frequency of stored energy state-of-charge levels, according to an example.

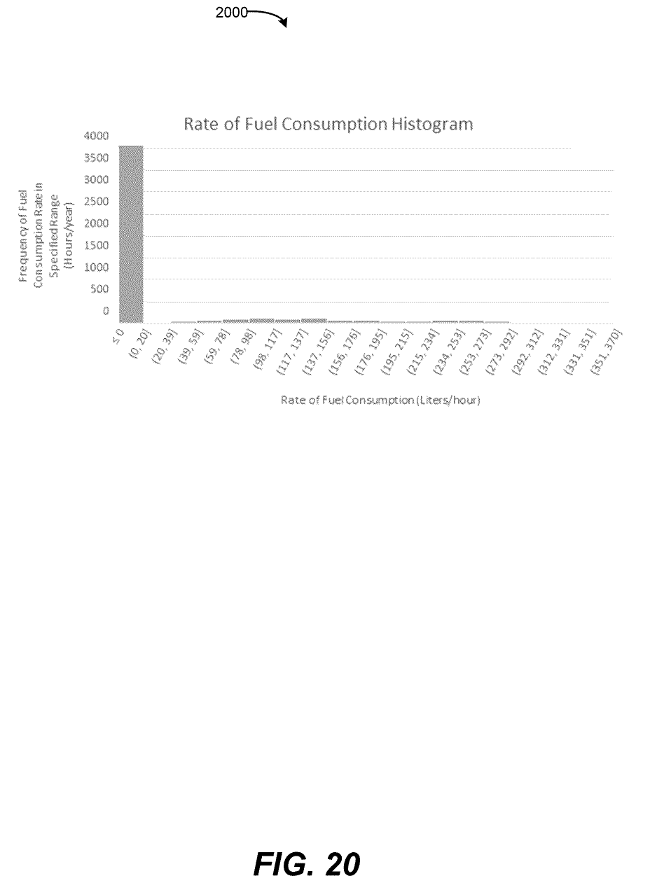

FIG. 20 is a chart 2000 of frequency of fuel-based sources operating with different rates of fuel consumption, according to an example.

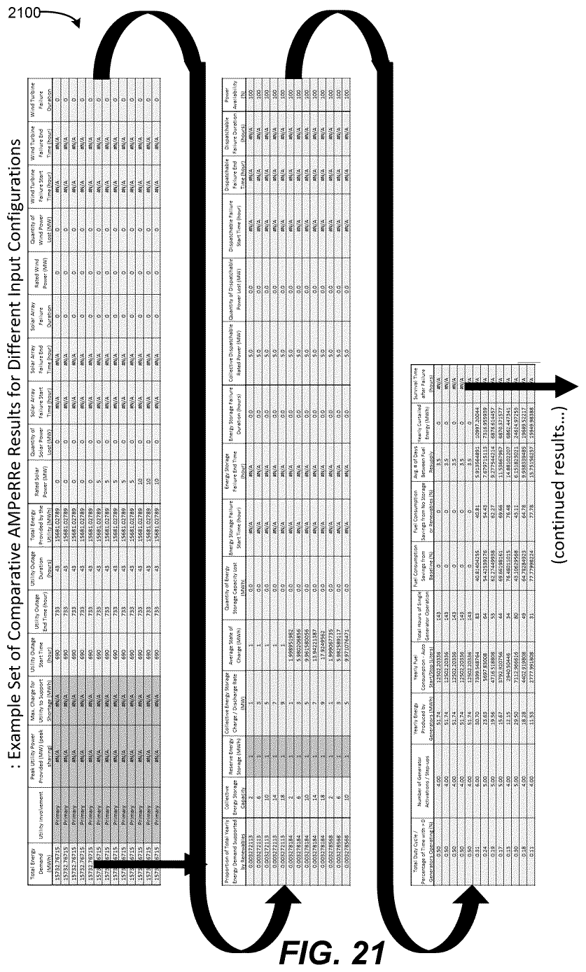

FIG. 21 is a table 2100 of a portion of a set of comparative AMPeRRe results for different input configurations, according to an example.

These example comparative results demonstrate how changes in the resource mix are expected to impact specific reliability and resilience-related outcomes. Each row in FIG. 21 represents the inputs and outputs from one run of the AMPeRRe model. Multiple rows feature varied inputs with differing outputs that allow for quantitative comparison of the forecasted outcomes among different power grid configurations.

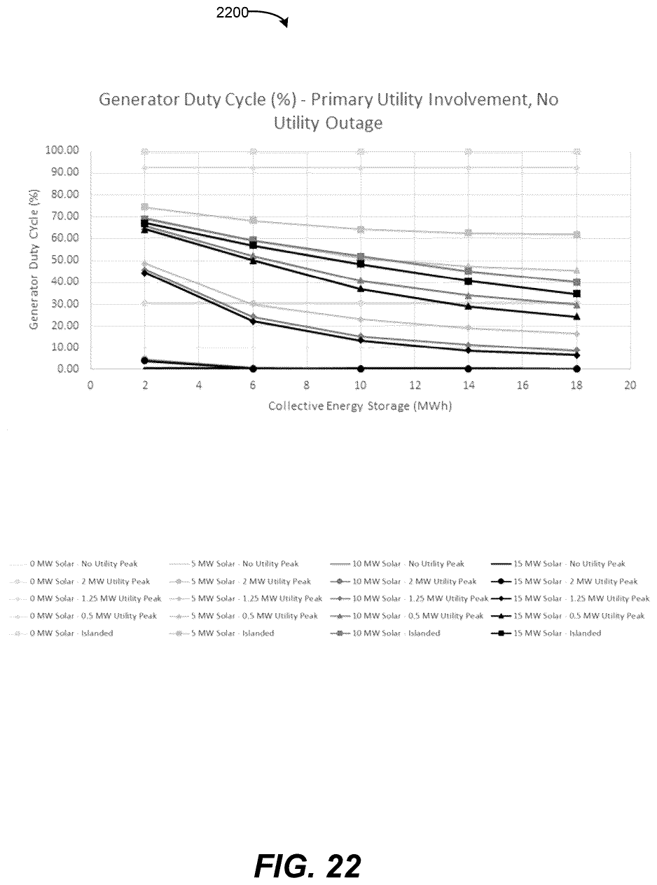

The following FIGS. 22-27 provide a visual example of these comparative results between multiple scenarios. In this example, the input module prompts for the user to vary the quantity of solar, energy storage, and utility peak-shaving for the evaluated power system. The x-axis in each plot represents varied energy storage, while different data series shown in the legend below each figure represent different quantities of solar and utility power limits. Dispatchable power source duty cycle is calculated as the proportion of time that any of the fuel-based dispatchable sources within the system are operating. This tends to decrease with an increase in renewables and/or energy storage, as both scenarios make power shortages less frequent and reduce need for dispatchable source operation.

FIG. 22 is a chart 2200 of dispatchable power source duty cycle (%) that assumes primary utility involvement and no utility outages, according to an example.

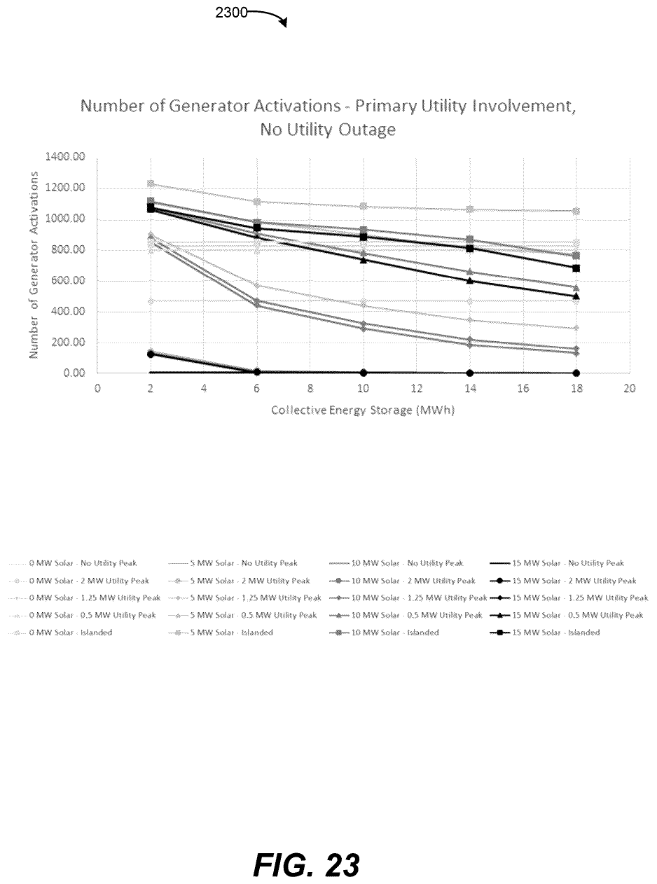

FIG. 23 is a chart 2300 of the number of times that a generator must activate over the course of a year, according to an example.

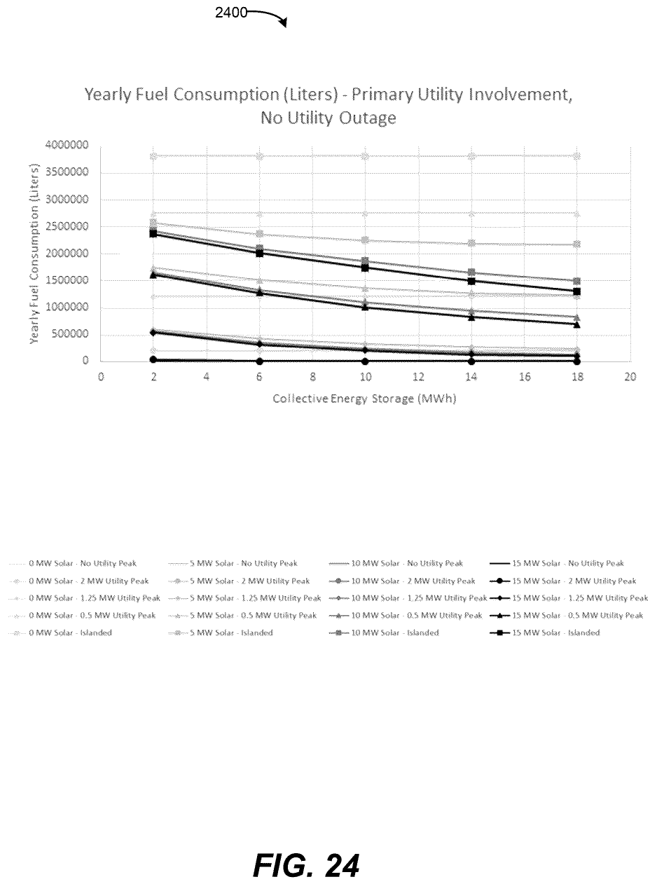

FIG. 24 is a chart 2400 comparing the yearly fuel consumption of different resource mix scenarios, according to an example. Higher quantities of renewable energy and energy storage are expected to lower forecasted fuel consumption.

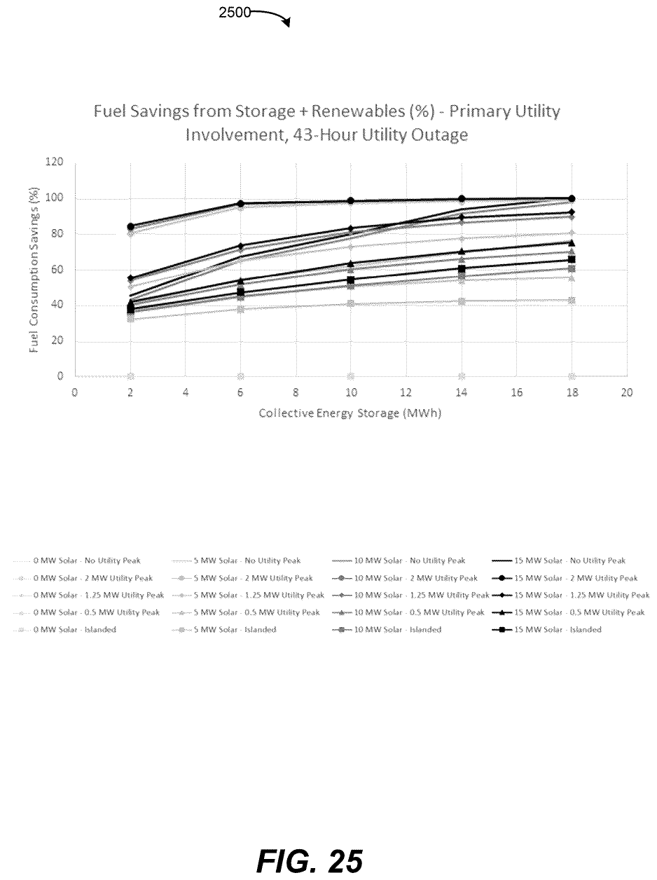

FIG. 25 is a chart 2500 showing the fuel savings caused by the inclusion of renewables and energy storage, according to an example. The fuel savings are shown compared to one baseline case that includes only dispatchable microgrid resources and utility involvement. Utility peak-shaving results in significant fuel increase, as dispatchable sources must operate more often due to limits placed on utility power. The inclusion of renewables and energy storage in these scenarios, however, can increase fuel savings as shown in this example.

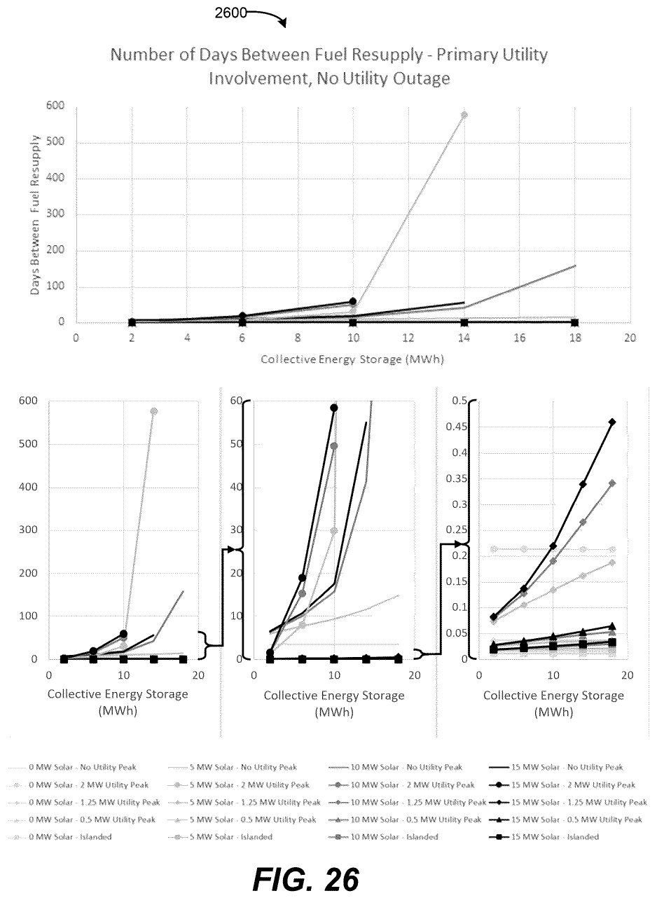

FIG. 26 is a chart 2600 showing the average number of days between fuel resupply needed to maintain constant fuel supply, according to an example. This value is inversely related to the rate of fuel consumption; it increases as the rate of fuel consumption decreases. The bottom section of the figure shows this plot at different y-axis scales to visualize scenarios with long periods between fuel resupply and scenarios that require frequent resupply.

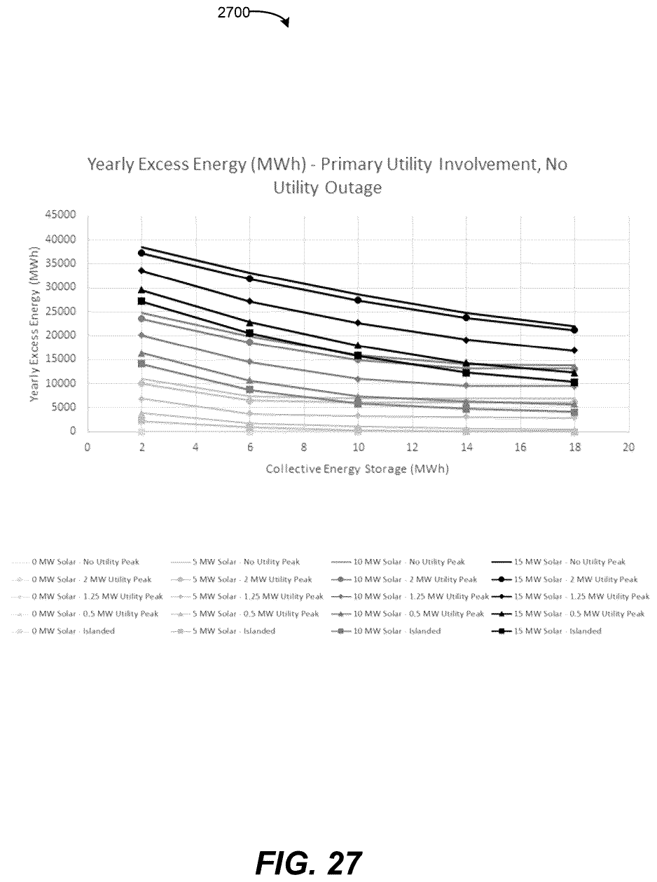

FIG. 27 is a chart 2700 showing the comparative excess energy produced in each power mix scenario. Excess energy is energy produced that exceeds what the energy storage system is capable of capturing. This energy may be filtered out, curtailed, or sold to the utility if the microgrid is utility connected.

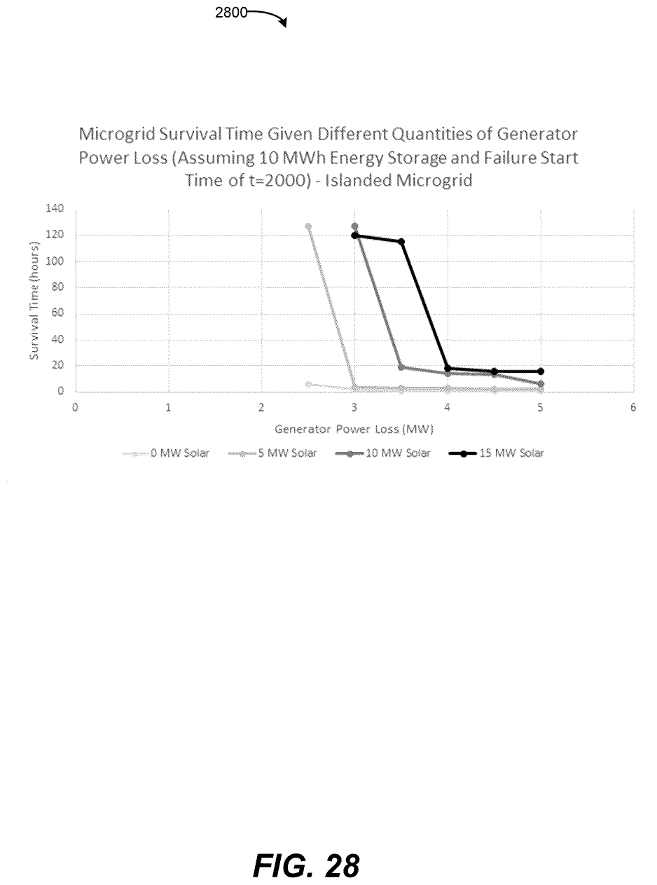

FIG. 28 is a chart 2800 showing microgrid survival time given different quantities of generator power loss, according to an example. In the context of the AMPeRRe model, survival time is defined as the time from the start of a power resource failure to the loss of power service to the load. AMPeRRe can forecast this metric for any combination of failures, but FIG. 28 demonstrates this calculation for different quantities of generator power loss.

AMPeRRe's forecasting module can also model any user-specified utility outages, and the forecasted results generator can show how these outages cause forecasted outcomes to deviate from a non-outage baseline scenario. A 500-hour utility outage was modeled to provide an example of these results below.

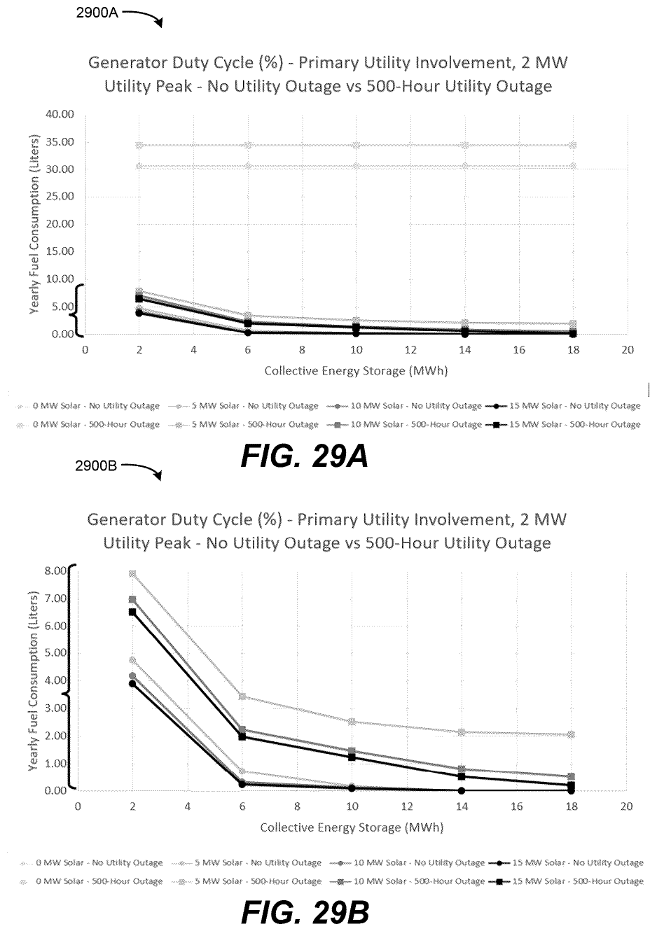

FIG. 29A and FIG. 29B are charts 2900A, 2900B showing generator duty cycle, according to an example. The charts show generator duty cycle results assuming primary utility involvement and a 2 MW utility peak for the case of no utility outage vs a 500-hour utility outage.

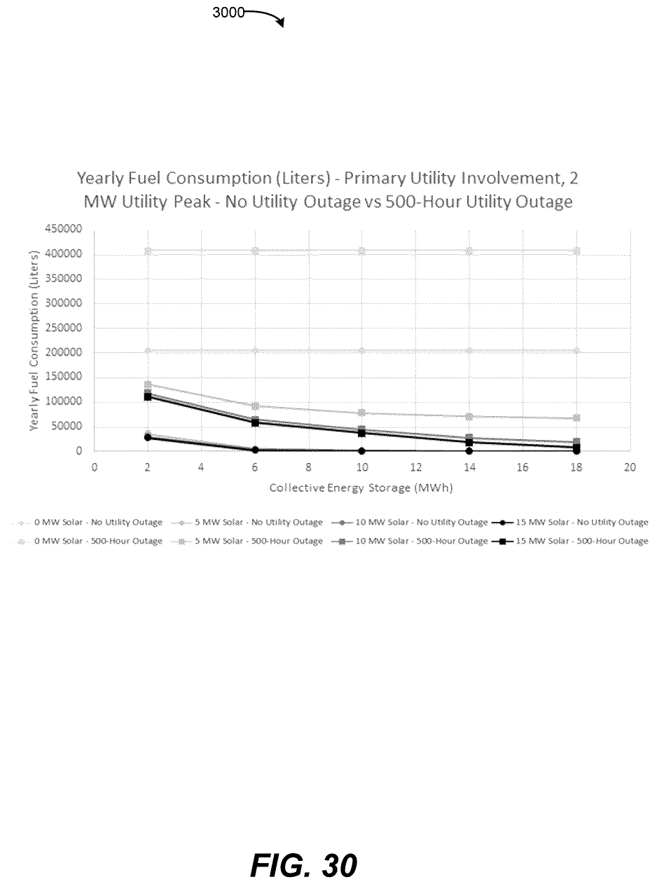

FIG. 30 is a chart 3000 showing yearly fuel consumption, according to an example. The chart shows yearly fuel consumption assuming primary utility involvement and a 2 MW utility peak for the case of no utility outage vs a 500-hour utility outage.

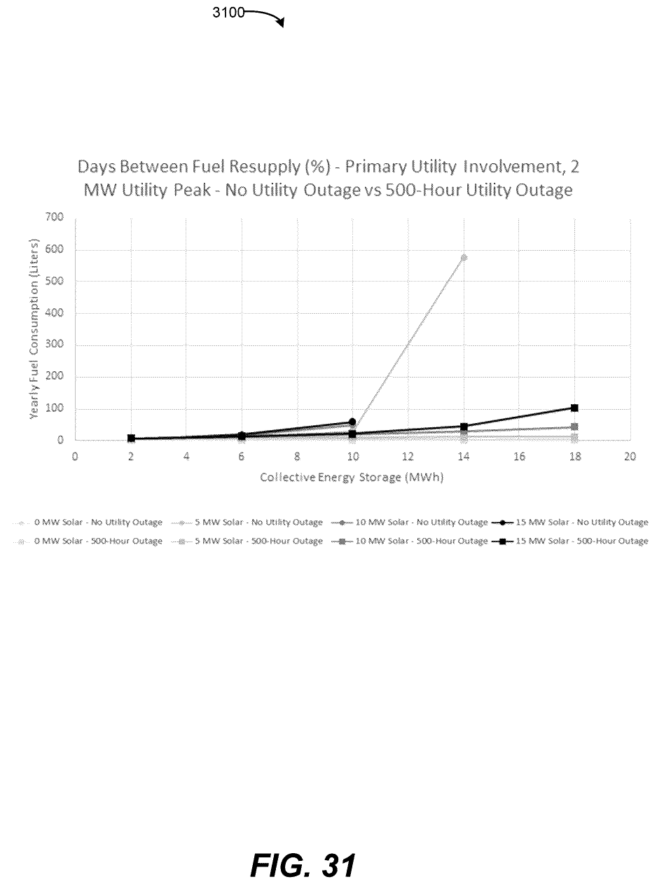

FIG. 31 is a chart 3100 showing days between fuel resupply, according to an example. This chart assumes primary utility involvement and a 2 MW utility peak for the case of no utility outage vs a 500-hour utility outage.

The following is an example of comparative results between AMPeRRe model variations. Power grid outcomes may vary depending on the prioritization of the on-site resources and involvement of the utility. Users may subsequently see differences in the microgrid outcomes forecasted by AMPeRRe depending on whether they select the “primary” or “integrated” variation of the utility-connected microgrid model. An example of these differences is shown in the figures below. Initial, notable differences include the quantity of energy provided by the utility versus on-site renewable sources.

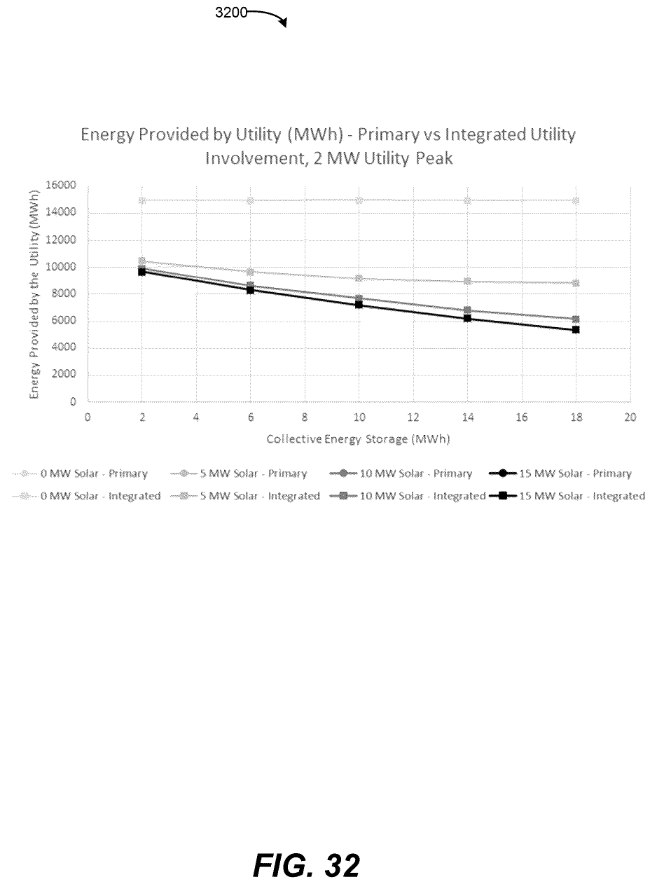

FIG. 32 is a chart 3200 showing energy provided by the utility (MWh), according to an example. FIG. 32 compares this quantity for primary vs integrated utility involvement at a 2 MW utility peak. In this example, the energy provided by the utility remains at a constant value of approximately 15000 MWh if it serves as a primary source regardless of the quantity of on-site solar or energy storage. Each of these primary-case plotted results overlap with the cases that assume no on-site renewables. The quantity of utility-provided energy decreases when the utility acts as an integrated source with a non-zero quantity of renewables (in this case, solar) and energy storage.

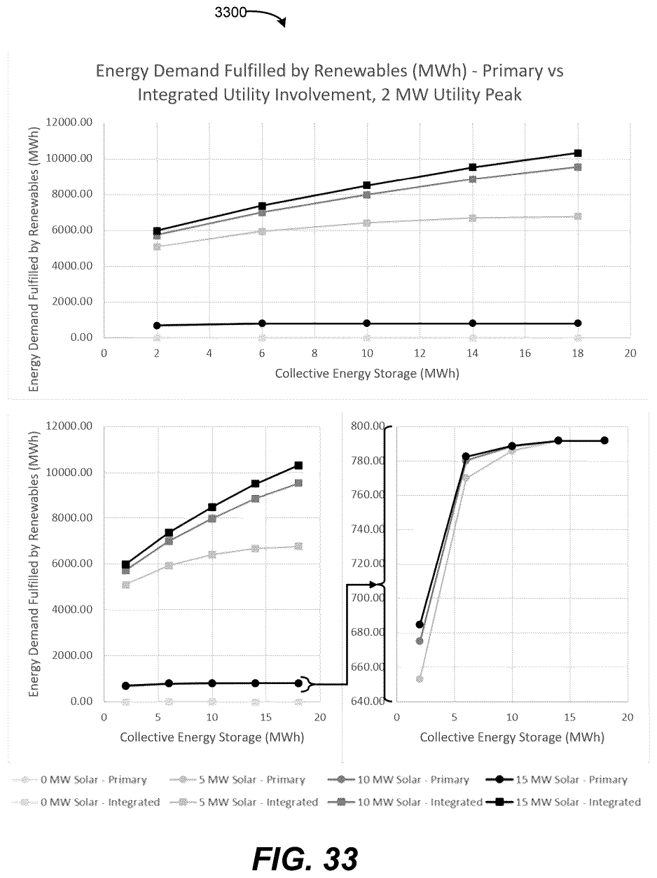

FIG. 33 is a chart 3300 showing the energy demand fulfilled by renewables, according to an example. FIG. 33 compares this quantity for primary vs integrated utility involvement at a 2 MW utility peak.

The energy contribution of renewable energy sources is expected to be greater with integrated utility involvement. AMPeRRe forecasts increased renewable source involvement because all available renewable power is contributed toward the load and energy storage before any other power is dispatched. Only two conditions limit the contribution of renewable power-when energy storage is at capacity and/or the power produced by on-site renewables (in surplus of load) is greater than the energy storage can capture. Since the utility is the first source to contribute to the load in the primary variation, the renewables only contribute towards any load that the utility is unable to fulfill. AMPeRRe has found, in this example case, that the renewable energy contribution from a system with integrated utility involvement would be significantly greater than that from a system with primary utility involvement regardless of the quantity of on-site renewable energy and energy storage.

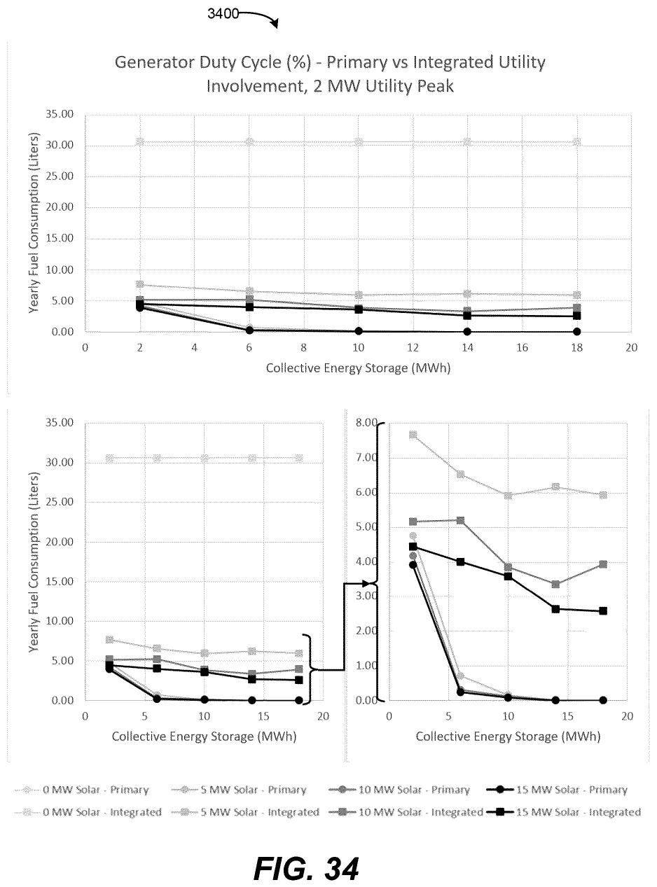

FIG. 34 is a chart 3400 showing generator duty cycle, according to an example. FIG. 34 compares this quantity for primary vs integrated utility involvement at a 2 MW utility peak.

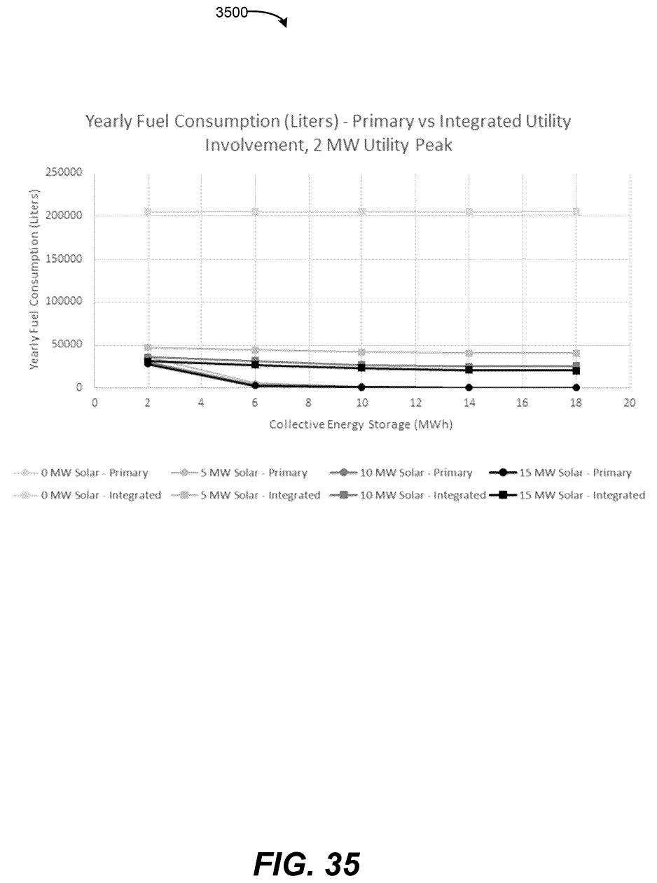

FIG. 35 is a chart 3500 showing yearly fuel consumption, according to an example. FIG. 35 compares this quantity for primary vs integrated utility involvement at a 2 MW utility peak.

The on-site fuel-based dispatchable sources would operate at a higher duty cycle (FIG. 34) and consume slightly more fuel (FIG. 35) in this example with an integrated microgrid compared to the primary utility scenario. While more fuel is consumed by the on-site resources in this scenario, less power is drawn from the utility. The net fuel savings may be greater if the provided utility power is predominantly fossil-fuel based.

Users can apply results such as these to quantifiably compare the outcomes of different power resource investments. This allows them to see tradeoffs and determine which sets of resources will enable their site or installation to reach its unique performance objectives. The plots will differ for each unique scenario that AMPeRRe models by accepting site-specific inputs from the user. Many of the trends will be similar, but exact quantified results will vary with each scenario. These quantified results can contribute to the development of a business case that justifies proposed investment into certain power resources. The results contribute to reducing the uncertainty surrounding the incorporation of intermittent renewable energy sources and supporting energy storage while showing how these technologies can make microgrids more self-sufficient, cost-effective, and environmentally friendly.

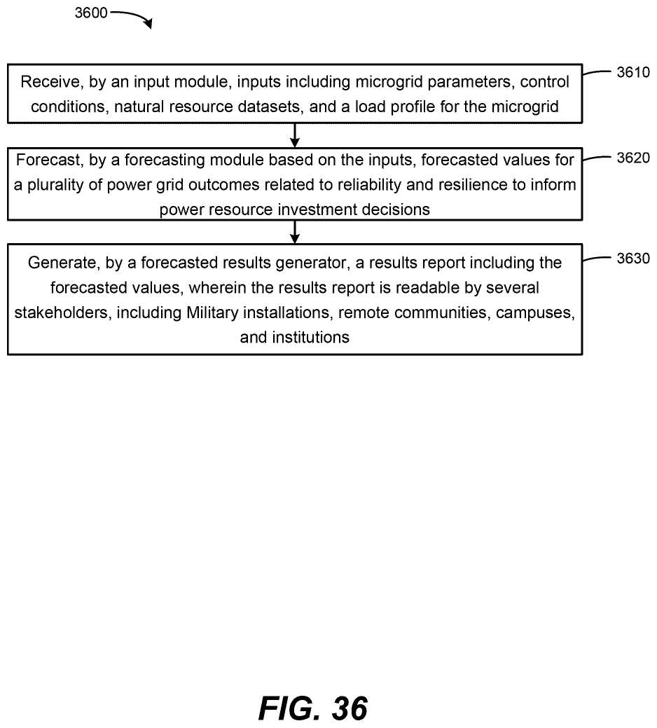

FIG. 36 is a flowchart 3600 to generate a results report according to an example. At 3610, an input module receives inputs including microgrid parameters, control conditions, natural resource datasets, and a load profile for the microgrid. At 3620, a forecasting module forecasts, based on the inputs, forecasted values for a plurality of power grid outcomes related to reliability and resilience to inform power resource investment decisions. At 3630, a forecasted results generator generates a results report including the forecasted values. The results report is readable by several stakeholders, including Military installations, remote communities, campuses, and institutions.

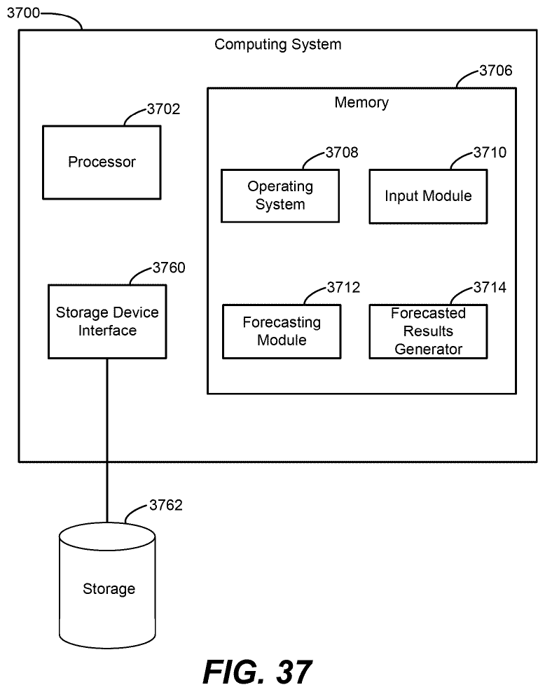

FIG. 37 is a block diagram of a computing system 3700 including an input module 3710, a forecasting module 3712, and a forecasted results generator 3714 according to an example. The computing system 3700 may include a processor 3702, memory 3706, and a storage device interface 3760. The memory 3706 of the computing system 3700 may be associated with an operating system 3708. The storage device interface 3760 must interface with stable storage 3762, such as one or more non-volatile volumes.

As this example demonstrates, the input module 3710, the forecasting module 3712, and the forecasted results generator 3714 are performed from the memory 3706 according to flowchart 3600 of FIG. 36.

Processor 3702 may be any combination of hardware and software that executes or interprets instructions, data transactions, codes, or signals. For example, processor 3702 can be a microprocessor, an Application-Specific Integrated Circuit (ASIC), a distributed processor such as a cluster or network of processors or computing device, or a virtual machine.

Storage device interface 3760 is a module in communication with processor 3702. Computing device 3700 may communicate via the storage device interface 3760 (e.g., to exchange symbols or signals representing data or information) with at least one stable storage 3762. Stable storage 3762 would store a number of data resources that may be organized in databases, key-value stores, data stores, and so on. Storage device interface 3760 may include hardware (e.g., pins, connectors, or integrated circuits) and software (e.g., drivers or communications stacks). For example, storage device interface 3760 can be a Parallel AT Attachment (PATA) interface, a Serial AT Attachment (SATA) interface, a Small Computer Systems Interface (SCSI) interface, a network (e.g., Ethernet, Fiber Channel, InfiniBand, Internet Small Computer Systems Interface (ISCSI), Storage Area Network (SAN), or Network File System (NFS)) interface, a Universal Serial Bus (USB) interface, or another storage device interface. Storage device interface 3760 can also include other forms of memory, including non-volatile random-access-memory (NVRAM), battery-backed random-access memory (RAM), phase change memory, and so on.

Memory 3706 is a processor-readable medium that stores instructions, codes, data, or other information. For example, memory 3706 can be a volatile random-access memory (RAM), a persistent or non-transitory data store such as a hard disk drive or a solid-state drive, or a combination thereof or other memories. Furthermore, memory 3706 can be integrated with processor 3702, separate from processor 3702, or external to computing device 3700.

Operating system 3708, the input module 3710, the forecasting module 3712, and the forecasted results generator 3714 may be instructions or code that, when executed at processor 3702, cause processor 3702 to perform operations that implement operating system 3708, the input module 3710, the forecasting module 3712, and the forecasted results generator 3714. In other words, operating system 3708, the input module 3710, the forecasting module 3712, and the forecasted results generator 3714, may be hosted at computing device 3700. More specifically, the input module 3710, the forecasting module 3712, and the forecasted results generator 3714 may include code or instructions that implement the features discussed above with reference to FIGS. 1-36.

In some implementations, the input module 3710, the forecasting module 3712, and the forecasted results generator 3714 (and/or other components, such as the various processes disclosed throughout) may be hosted or implemented at a computing device appliance (or appliance). That is, the input module 3710, the forecasting module 3712, and the forecasted results generator 3714 and/or other components may be implemented at a computing device that is dedicated to hosting the input module 3710, the forecasting module 3712, and the forecasted results generator 3714. For example, the input module 3710, the forecasting module 3712, and the forecasted results generator 3714 can be hosted at a computing device with a minimal or “just-enough” operating system. Furthermore, the input module 3710, the forecasting module 3712, and the forecasted results generator 3714 may be the only, exclusive, or primary software application hosted at the appliance.

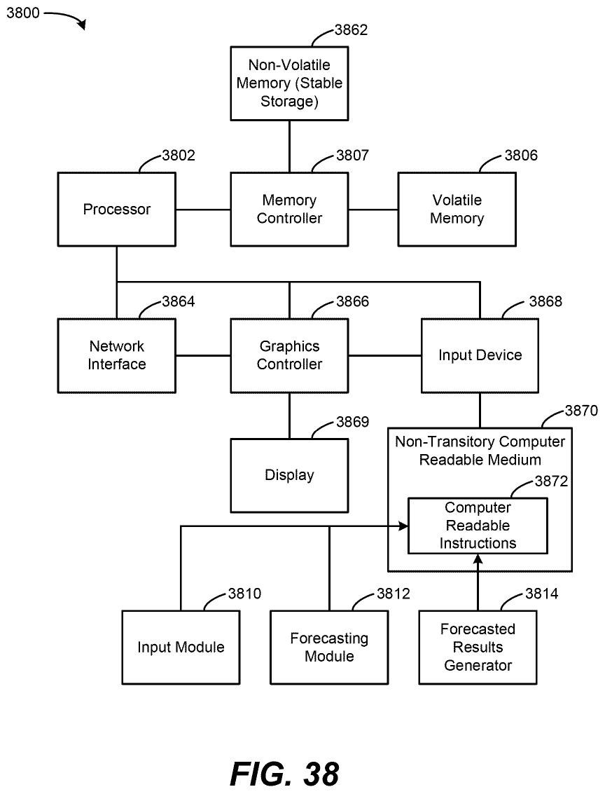

FIG. 38 is a block diagram of a computing system 3800 including an input module 3810, a forecasting module 3812, and a forecasted results generator 3814 according to an example. Examples described herein may be implemented in hardware, software, or a combination of both. Computing system 3800 may include a processor 3802 and memory resources, such as, for example, the volatile memory 3806 and/or the non-volatile memory 3862, for executing instructions stored in a tangible non-transitory medium (e.g., volatile memory 3806, non-volatile memory 3862, and/or computer readable medium 3870). The non-transitory computer-readable medium 3870 can have computer-readable instructions 3872 stored thereon that are executed by the processor 3802 to implement the input module 3810, the forecasting module 3812, and the forecasted results generator 3814 according to the present examples.

A machine (e.g., computing system 3800) may include and/or receive a tangible non-transitory computer-readable medium 3870 storing a set of computer-readable instructions 3872 (e.g., software) via an input device 3868. As used herein, the processor 3802 can include one or a plurality of processors such as in a parallel processing system. The memory 3806 can include memory addressable by the processor 3802 for execution of computer readable instructions. The computer readable medium 3870 can include volatile and/or non-volatile memory such as a random-access memory (RAM), magnetic memory such as a hard disk, floppy disk, and/or tape memory, a solid-state drive (SSD), flash memory, phase change memory, and so on. In some embodiments, the non-volatile memory 3862 can be a local or remote database including a plurality of physical non-volatile memory devices.

The processor 3802 can control the overall operation of the computing system 3800. The processor 3802 can be connected to a memory controller 3807, which can read and/or write data from and/or to volatile memory 3806 (e.g., random access memory (RAM)). The processor 3802 can be connected to a bus to provide communication between the processor 3802, the network interface 3864, and other portions of the computing system 3800. The non-volatile memory 3862 can provide persistent data storage for the computing system 3800. Further, the graphics controller 3866 can connect to a display 3869.

A computing system 3800 can include a computing device including control circuitry such as a processor, a state machine, ASIC, controller, and/or similar machine. As used herein, the indefinite articles “a” and/or “an” can indicate one or more than one of the named objects. Thus, for example, “a processor” can include one or more than one processor, such as in a multi-core processor, cluster, or parallel processing arrangement.

The present disclosure is not intended to be limited to the examples shown herein, but is to be accorded the widest scope consistent with the principles and novel features disclosed herein. For example, it is appreciated that the present disclosure is not limited to a particular configuration, such as computing system 3800. The various illustrative modules and steps described in connection with the examples disclosed herein may be implemented as electronic hardware, computer software, or combinations of both. Examples may be implemented using software modules, hardware modules or components, or a combination of software and hardware modules or components. Thus, in an example, one or more of the example steps and/or blocks described herein may comprise hardware modules or components. In another example, one or more of the steps and/or blocks described herein may comprise software code stored on a computer readable storage medium, which is executable by a processor.

To clearly illustrate this interchangeability of hardware and software, various illustrative components, blocks, modules, and steps have been described generally in terms of their functionality (e.g., the input module 3810, the forecasting module 3812, and the forecasted results generator 3814). Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

What is claimed is:

1. A discrete, time-domain computational method to find optimal power resources in a microgrid for reliability and resilience, comprising:
receiving, by an input module, inputs including microgrid parameters, control conditions, natural resource datasets, and a load profile for the microgrid;
forecasting, by a forecasting module based on the inputs, forecasted values for a plurality of power grid outcomes related to reliability and resilience to inform power resource investment decisions; and
generating, by a forecasted results generator, a results report including the forecasted values, wherein the results report is readable by several stakeholders, including Military installations, remote communities, campuses, and institutions.

2. The method of claim 1, further comprising prompting, by the input module, user selection of the control conditions including prompting for one of three variations of power resource prioritization, the variations including:
islanded microgrid systems, which operate without utility power involvement;
utility-connected systems including a supporting microgrid, wherein a utility acts as a primary power resource, and on-site microgrid resources contribute when the utility is limited or experiences outage; and
utility-connected systems including an integrated microgrid, wherein on-site renewable microgrid resources and energy storage of the integrated microgrid act as primary power sources, and utility power, along with fuel-based dispatchable power, contributes when the renewable microgrid resources and energy storage are in shortage to a load;
wherein the inputs correspond to the one of the three variations which the user selected.

3. The method of claim 1, further comprising:
determining intermittent renewable power vs time based on the inputs including system parameters, natural resources, and load profile, wherein the intermittent renewable power vs time includes a surplus or shortage of renewable power vs load for the microgrid at any given time; and
determining, based on calculated power production from each source and surplus or shortage at every timestep, power availability of the microgrid.

4. The method of claim 1, further comprising:
determining, based on the control system inputs and calculated power production from each user-input power source, a plurality of charge and discharge cycles for a plurality of stored energy dispatchable sources to enable the microgrid to reach 100% power availability; and
determining, based on the plurality of stored energy charge and discharge cycles, the stored energy vs time of the plurality of stored energy dispatchable sources.

5. The method of claim 1, further comprising:
determining, based on the calculated timesteps of necessary dispatchable power source involvement, a plurality of duty cycles for a plurality of fuel-based dispatchable sources to enable the microgrid to reach 100% power availability; and
determining, based on the plurality of duty cycles, needed power production and fuel consumption of the plurality of fuel-based dispatchable sources.

6. The method of claim 1, further comprising determining, based on known fuel storage capacity or the frequency of fuel resupply for a baseline case, an average number of days the microgrid can operate before needing fuel resupply for dispatchable sources that are fuel-based.

7. The method of claim 1, further comprising determining, based on energy storage parameter inputs and a load profile, a number of days the microgrid can operate using only stored energy dispatchable sources before needing replenished charge to prevent losing power availability.

8. The method of claim 1, further comprising determining, based on an input combination of power resource losses, a survival time corresponding to a start of the component losses until a loss of power service that the microgrid provides to a load.

9. The method of claim 1, further comprising receiving an input of utility power limit to emulate peak shaving, and modeling how the microgrid responds to peak shaving.

10. The method of claim 9, further comprising:
determining, based on the selected power resource prioritization variation and the input utility power limit, utility energy contribution needed to enable the microgrid to reach 100% power availability; and
determining, based on the utility contribution, a frequency of utility involvement, utility power provided vs time, and percentage of power shortage supported by the utility contribution.

11. The method of claim 1, further comprising:
determining, based on the selected power resource prioritization variation and dispatchable power source parameter inputs, energy contribution of dispatchable sources needed to enable the microgrid to reach 100% power availability; and
determining, based on the contribution by dispatchable power sources, frequency of dispatchable source involvement, dispatchable source power provided vs time, and percentage of shortage supported by dispatchable sources.

12. The method of claim 11, further comprising receiving an input of dispatchable source power limit, and modeling how the microgrid responds to the dispatchable source power limit.

13. The method of claim 1, wherein the results report includes side-by-side comparative results for different user-input power resource scenarios, the method further comprising quantifying an impact of resource changes on each forecasted power grid outcome, and prompting for user selection of a power mix that would best achieve their objectives.

14. A non-transitory computer readable medium having instructions stored thereon executable by a processor to perform a discrete, time-domain computation that finds optimal power resources in a microgrid for reliability and resilience, the instructions, when executed, causing the processor to:
receive, by an input module, inputs including microgrid parameters, control conditions, natural resource datasets, and a load profile for the microgrid;
forecast, by a forecasting module based on the inputs, forecasted values for a plurality of power grid outcomes related to reliability and resilience to inform power resource investment decisions; and
generate, by a forecasted results generator, a results report including the forecasted values, wherein the results report is readable by several stakeholders, including Military installations, remote communities, campuses, and institutions.

15. The non-transitory computer readable medium of claim 14, further comprising instructions stored thereon executable by a processor to:
prompt, by the input module, user selection of the control conditions including prompting for one of three variations of power resource prioritization, the variations including:
islanded microgrid systems, which operate without utility power involvement;
utility-connected systems including a supporting microgrid, wherein a utility acts as a primary power resource, and on-site microgrid resources contribute when the utility is limited or experiences outage; and
utility-connected systems including an integrated microgrid, wherein on-site renewable microgrid resources and energy storage of the integrated microgrid act as primary power sources, and utility power, along with fuel-based dispatchable power, contributes when the renewable microgrid resources and energy storage are in shortage to a load;
wherein the inputs correspond to the one of the three variations which the user selected.

16. The non-transitory computer readable medium of claim 14, further comprising instructions stored thereon executable by a processor to:
determine intermittent renewable power vs time based on the inputs including system parameters, natural resources, and load profile, wherein the intermittent renewable power vs time includes a surplus or shortage of renewable power vs load for the microgrid at any given time; and
determine, based on calculated power production from each source and surplus or shortage at every timestep, power availability of the microgrid.

17. The non-transitory computer readable medium of claim 14, further comprising instructions stored thereon executable by a processor to:
determine, based on the control system inputs and calculated power production from each user-input power source, a plurality of charge and discharge cycles for a plurality of stored energy dispatchable sources to enable the microgrid to reach 100% power availability; and
determine, based on the plurality of stored energy charge and discharge cycles, the stored energy vs time of the plurality of stored energy dispatchable sources.

18. The non-transitory computer readable medium of claim 14, further comprising instructions stored thereon executable by a processor to:
determine, based on the calculated timesteps of necessary dispatchable power source involvement, a plurality of duty cycles for a plurality of fuel-based dispatchable sources to enable the microgrid to reach 100% power availability; and
determine, based on the plurality of duty cycles, needed power production and fuel consumption of the plurality of fuel-based dispatchable sources.

19. The non-transitory computer readable medium of claim 14, further comprising instructions stored thereon executable by a processor to determine, based on known fuel storage capacity or the frequency of fuel resupply for a baseline case, an average number of days the microgrid can operate before needing fuel resupply for dispatchable sources that are fuel-based.

20. The non-transitory computer readable medium of claim 14, further comprising instructions stored thereon executable by a processor to determine, based on energy storage parameter inputs and a load profile, a number of days the microgrid can operate using only stored energy dispatchable sources before needing replenished charge to prevent losing power availability.

21. The non-transitory computer readable medium of claim 14, further comprising instructions stored thereon executable by a processor to determine, based on an input combination of power resource losses, a survival time corresponding to a start of the component losses until a loss of power service that the microgrid provides to a load.

22. The non-transitory computer readable medium of claim 14, further comprising instructions stored thereon executable by a processor to receive an input of utility power limit to emulate peak shaving, and model how the microgrid responds to peak shaving.

23. The non-transitory computer readable medium of claim 14, further comprising instructions stored thereon executable by a processor to:
determine, based on the selected power resource prioritization variation and the input utility power limit, utility energy contribution needed to enable the microgrid to reach 100% power availability; and
determine, based on the utility contribution, a frequency of utility involvement, utility power provided vs time, and percentage of power shortage supported by the utility contribution.

24. The non-transitory computer readable medium of claim 14, further comprising instructions stored thereon executable by a processor to:
determine, based on the selected power resource prioritization variation and dispatchable power source parameter inputs, energy contribution of dispatchable sources needed to enable the microgrid to reach 100% power availability; and
determine, based on the contribution by dispatchable power sources, frequency of dispatchable source involvement, dispatchable source power provided vs time, and percentage of shortage supported by dispatchable sources.

25. The non-transitory computer readable medium of claim 14, further comprising instructions stored thereon executable by a processor to receive an input of dispatchable source power limit, and model how the microgrid responds to the dispatchable source power limit.

26. The non-transitory computer readable medium of claim 14, wherein the results report includes side-by-side comparative results for different user-input power resource scenarios, the non-transitory computer readable medium further comprising instructions stored thereon executable by a processor to quantify an impact of resource changes on each forecasted power grid outcome, and prompt for user selection of a power mix that would best achieve their objectives.
